(19) United States
(12) Patent Application Publication
(10) Pub. No.: US 2018/0115086 A1
(43) Pub. Date: Apr. 26, 2018

(54) RETENTION BRACKET FOR BREAKOUT SUPPORT

(71) Applicant: Kymeta Corporation, Redmond, WA (US)

(72) Inventors: Stephen Olfert, Kent, WA (US); Benjamin Ash, Seattle, WA (US); Andrew Turner, Seattle, WA (US); Mehdi Afkahmi, Kirkland, WA (US)

(21) Appl. No.: 15/790,672

(22) Filed: Oct. 23, 2017

Related U.S. Application Data
(60) Provisional application No. 62/412,099, filed on Oct. 24, 2016.

(51) Int. Cl. H01Q 21/00; H04L 12/28; H01Q 1/12; H01Q 1/22

(52) U.S. Cl. CPC H01Q 21/0087; H04L 12/282; G05B 15/02; H01Q 1/2283; H01Q 1/125

(57) ABSTRACT

A method and apparatus is disclosed herein for supporting an antenna and its components. In one embodiment, a retention apparatus for use in coupling to an antenna aperture during manufacturing comprises: a base plate; a plurality of clamps coupled to the base plate, each clamp of the plurality of clamps being rotatable to couple the antenna aperture to the base plate; and one or more component holders coupled to the base plate, each of the one or more component holders to securely hold at least one component that is coupled to the antenna aperture.

### PRIORITY

The present patent application claims priority to and incorporates by reference the corresponding provisional patent application Ser. No. 62/412,099, titled, “Retention Bracket for Breakout Support,” filed on Oct. 24, 2016.

### FIELD OF THE INVENTION

Embodiments of the present invention relate to the field of antennas for wireless communication; more particularly, embodiments of the present invention relate to a tool to hold at least a portion of an antenna during manufacturing.

### BACKGROUND

There are a number of challenges in manufacturing antennas that are used in satellite communication. One of the problems that occurs during manufacturing is the handling of loose parts. As an antenna is being manufactured, there are often parts that are coupled loosely to the antenna. For example, some antennas include printed circuit boards (PCBs) that are connected to other portions of the antenna using flexible (flex) cables. If such an antenna must be moved during the manufacturing process, those PCBs must be secured; otherwise, the PCBs and/or the flex cables to which they are attached could be damaged.

Tools are often available to help with the manufacture of individual antennas. However, these tools often lack usability in that they do not accommodate all the individuals that may be involved in the manufacturing process or are difficult to use. Another problem with using these tools is that they often increase the cost to build out an antenna, thereby impacting profit margins.

### SUMMARY OF THE INVENTION

A method and apparatus is disclosed herein for supporting an antenna and its components. In one embodiment, a retention apparatus for use in coupling to an antenna aperture during manufacturing comprises: a base plate; a plurality of clamps coupled to the base plate, each clamp of the plurality of clamps being rotatable to couple the antenna aperture to the base plate; and one or more component holders coupled to the base plate, each of the one or more component holders to securely hold at least one component that is coupled to the antenna aperture.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1A illustrates one embodiment of a base plate.

FIG. 1B illustrates one embodiment of a base plate with components mounted thereon.

FIG. 2A illustrates one embodiment of a L-Iron bracket.

FIG. 2B illustrates one embodiment of L-Iron bracket mounted to base with an attached handle.

FIG. 3A illustrates one embodiment of a T-Iron mounting and index features.

FIG. 3B illustrates one embodiment of a T-Iron notches and cutouts.

FIG. 3C illustrates one embodiment of a I-Iron notches and cutouts.

FIG. 3D illustrates one embodiment of a T-Iron fence and electrostatic discharge (ESD) foam cushion.

FIG. 4A illustrates one embodiment of a retainer plate features.

FIG. 4B illustrates one embodiment of a clamp plate with ESD foam.

FIG. 4C illustrates one embodiment of a retainer plate shield and ESD foam.

FIG. 4D illustrates one embodiment of a draw latch holding retainer plate in place.

FIG. 5 illustrates one embodiment of a base plate with ESD cushion foam.

FIG. 6 illustrates one embodiment of T-iron foam with cutouts.

FIG. 7 illustrates one embodiment of a standoff.

FIG. 8 illustrates one embodiment of radome clamping.

FIG. 9 is a flowchart of one embodiment of a process for manufacturing an antenna

FIG. 10 illustrates an aperture having one or more arrays of antenna elements placed in concentric rings around an input feed of the cylindrically fed antenna.

FIG. 11 illustrates a perspective view of one row of antenna elements that includes a ground plane and a reconfigurable resonator layer.

FIG. 12 illustrates one embodiment of a tunable resonator/slot.

FIG. 13 illustrates a cross section view of one embodiment of a physical antenna aperture.

FIGS. 14A-D illustrate one embodiment of the different layers for creating the slotted array.

FIG. 15 illustrates a side view of one embodiment of a cylindrically fed antenna structure.

FIG. 16 illustrates another embodiment of the antenna system with an outgoing wave.

FIG. 17 illustrates one embodiment of the placement of matrix drive circuitry with respect to antenna elements.

FIG. 18 illustrates one embodiment of a TFT package.

FIG. 19 is a block diagram of one embodiment of a communication system that performs dual reception simultaneously in a television system.

FIG. 20 is a block diagram of another embodiment of a communication system having simultaneous transmit and receive paths.

FIG. 21 illustrates one embodiment of the retention bracket without an antenna aperture coupled thereto.

FIG. 22 illustrates a portion of one embodiment of the retention bracket with a breakout board attached to an antenna aperture with a flex cable without a retainer plate (uncovered).

FIG. 23 illustrates one embodiment of the retention bracket with an antenna aperture coupled thereto and being held with L iron brackets pointing above the antenna aperture.

FIG. 24 illustrates an example of one embodiment of the retention bracket with an antenna aperture coupled thereto flipped so that L iron brackets support the retention bracket on a surface.

### DETAILED DESCRIPTION OF THE PRESENT INVENTION

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

### Overview

Embodiments of the invention include a device referred to herein as a retention bracket used to hold an antenna aperture during the manufacturing process and a method for using the same. In one embodiment, the retention bracket holds the antenna aperture by clamping itself to the top cover of the antenna aperture. In one embodiment, the top cover is a radome. In one embodiment, the retention bracket holds in place a radome and a wide-angle impedance match (WAIM) network coupled to the radome. In one embodiment, the aperture is a thin film transistor (TFT) aperture containing antenna elements and circuitry to control the antenna elements (e.g., gates to turn off/on antenna elements, circuitry to apply voltages to antenna elements, etc.). In one embodiment, the aperture is a segmented aperture having a number of segments with antenna elements, which when coupled together with other such segments, forms an array of antenna elements. Examples of such antenna apertures are described in greater detail below.

In one embodiment, the retention bracket disclosed herein supports one or more breakout boards and flex connectors that are coupled to the antenna aperture so they are protected during the assembly process. In one embodiment, these breakout boards and flex connectors are coupled to the antenna elements and TFT circuits controlling the antenna elements on the apertures. The breakout boards and flex connectors are loosely coupled to the antenna aperture and are secured by the retention bracket during the manufacturing. In one embodiment, other loose components are secured by the retention bracket during manufacturing. For example, in one embodiment, loose components such as temperature sensing devices or other sensors could be secured in this manner.

Note that embodiments of the retention bracket disclosed herein may be used with a variety of antennas including, for example, but not limited to, a maritime antenna; however, its use is also applicable with only slight modification to any such segmented aperture where the TFT segments are attached/bonded to a rigid carrier.

### Example Embodiments of the Retention Bracket

In one embodiment, a retention bracket for use in coupling to an antenna aperture during manufacturing comprises: a base plate; a plurality of clamps coupled to the base plate, where each clamp of the plurality of clamps is rotatable to couple the antenna aperture to the base plate; and one or more component holders coupled to the base plate, each of the one or more component holders to securely hold at least component that is coupled to the antenna aperture. In one embodiment, the base plate has a centrally located open area and has foam to cushion a cover of the antenna aperture when the antenna aperture rests on a portion of the base plate and is clamped to the base plate. In one embodiment, the cover is a radome.

In one embodiment, the one or more components comprise printed circuit substrates (e.g., boards) with one or more integrated circuit components coupled thereto. In one embodiment, each of the one or more component holders comprises a first bracket (e.g., a T-Iron bracket, etc.) and a removable retainer plate coupled to the first bracket. In one embodiment, a first foam cushion is attached to the first bracket and a second foam cushion is attached to the retainer plate to cushion the antenna component when the first bracket and the retainer plate are coupled together. In one embodiment, the retention bracket comprises a plurality of latches coupled to the first bracket and the removable retainer plate to cause the first bracket and the removable retainer plate to clamp towards each other to secure at least one antenna component (e.g., a breakout or other PCB board) that is coupled to the antenna aperture. In one embodiment, the first bracket comprises a T-Iron bracket and the latch comprises a strikeless draw latch.

In one embodiment, the retention bracket further comprises: a plurality of rods, where each rod of the plurality rods is coupled to a distinct clamp of the plurality of clamps; and a plurality of nuts, where each nut of the plurality nuts is coupled to a distinct rod of the plurality of rods and to secures a clamp in place when the clamp couples the base plate to the aperture.

In one embodiment, the retention bracket further comprises a plurality of standoffs coupled to the base plate.

In one embodiment, the retention bracket further comprises a plurality of second brackets (e.g., L iron brackets, etc.) coupled to the base plate for handling the base plate. In one embodiment, the retention bracket comprises a plurality of handles, each handle of the plurality of handles being coupled to a distinct one of the plurality of second brackets.

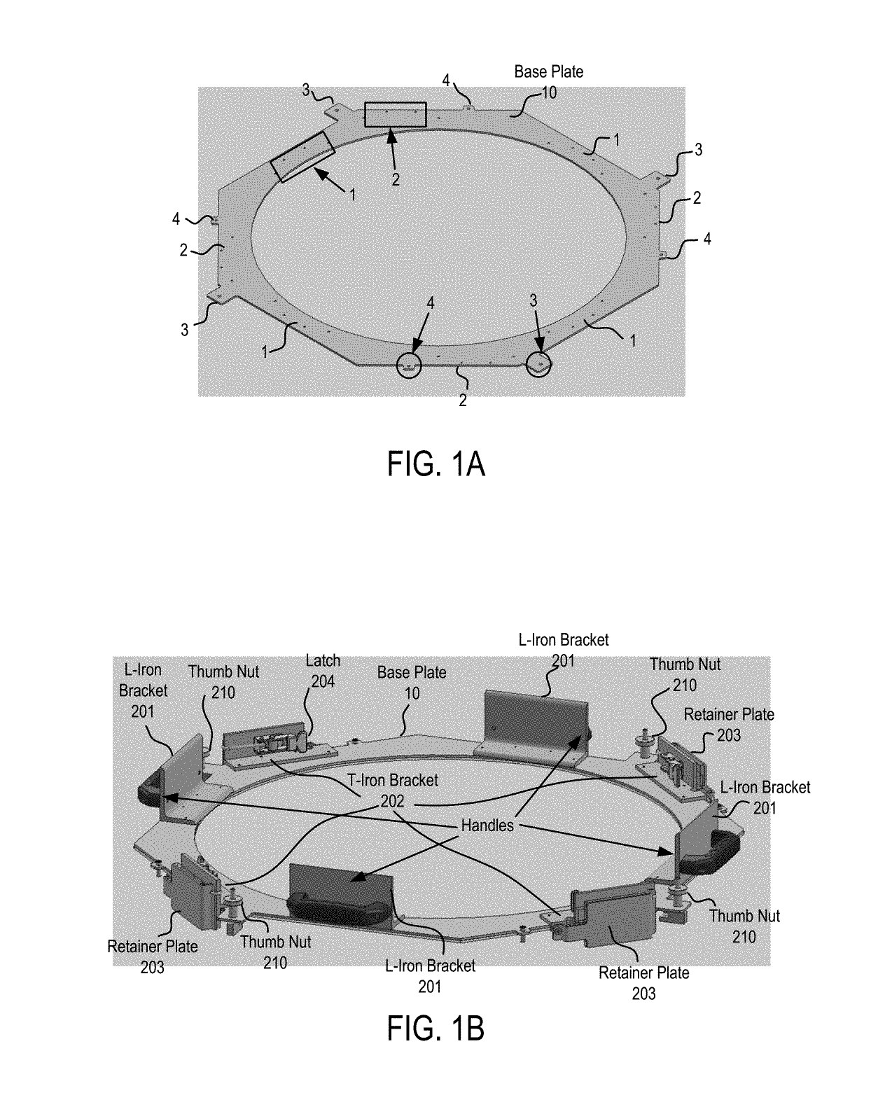

FIG. 1A illustrates one embodiment of a base plate. Referring to FIG. 1A, base plate 10 has mounting features for the rest of the parts of the retention bracket apparatus. Location 1 of base plate 10 is where an L iron bracket mounts; location 2 is where a T-iron bracket mounts; location 3 is where a swiveling clamp mounts; and location 4 is where a standoff index mounts.

In one embodiment, base plate 10 has holes that are used to mount the L-Irons and the T-irons. In one embodiment, the holes for mounting the L iron brackets and the T-iron brackets are sized for use with 6-32 screws. In one embodiment, base plate 10 has clearance holes to mount standoffs. In one embodiment, these clearance holds mount the standoffs with 10-32 screws.

In one embodiment, base plate 10 has clearance holes for the ¼-20 threaded rods. These threaded rods pass through base plate 10 and screw into the clamps when they are bonded in place. In one embodiment, they are bonded in place with Loctite. Note that other bonding materials may be used other than Loctite.

In one embodiment, base plate 10 has foam to provide cushion for the top of the antenna aperture when the antenna aperture is placed onto and held by base plate 10. In one embodiment, base plate 10 has 0.25″ electrostatic discharge (ESD) foam bonded to it with pressure sensitive adhesive (PSA) or another well-known adhesive to provide cushion for a painted radome surface that acts as a cover for the antenna aperture.

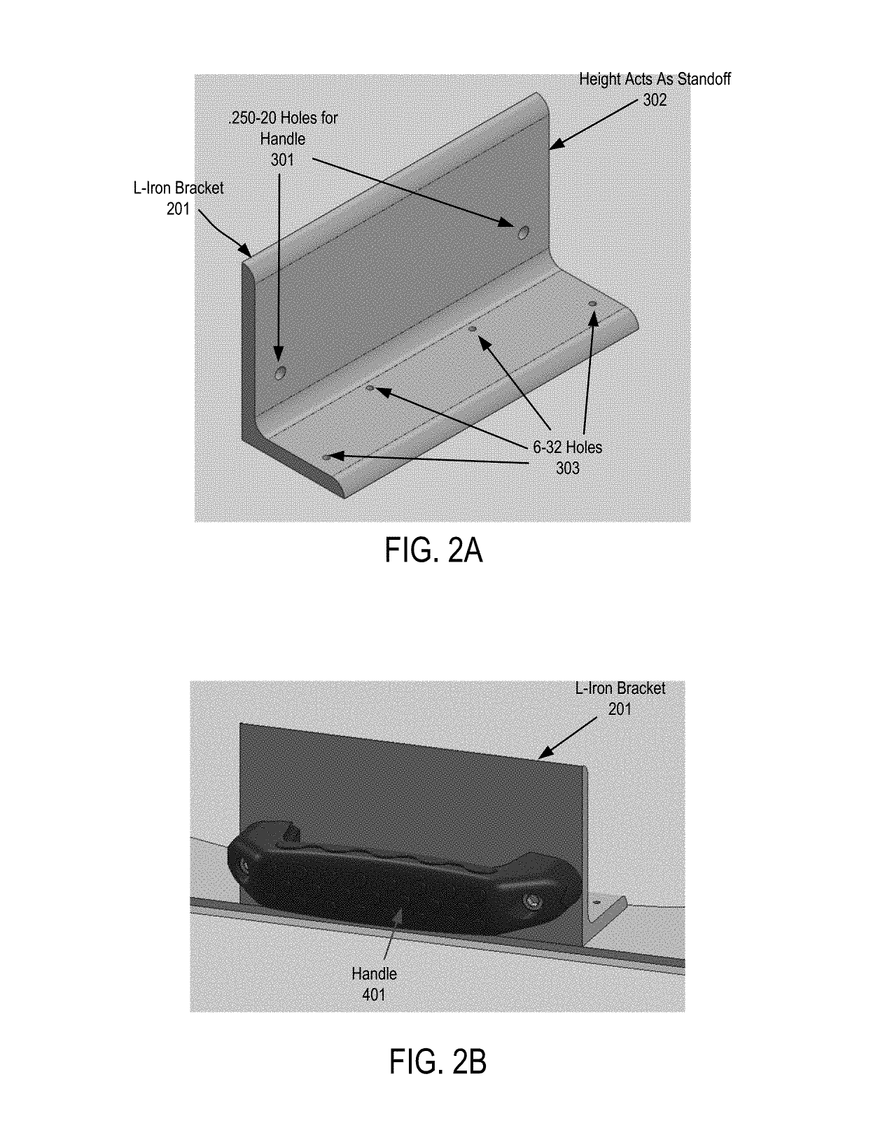

FIG. 1B illustrates one embodiment of a base plate with components mounted thereon. Referring to FIG. 1B, L iron brackets 201 are mounted to base plate 10. In one embodiment, L iron brackets 201 mounts to base plate with 6-32 screws. FIG. 2A illustrates one embodiment of a L-Iron bracket. Referring to FIG. 2A, in one embodiment, L iron bracket 201 includes holes 303 for mounting to a base plate, such as base plate 10, with screws. In one embodiment, Loctite or another known adhesive is used on the screws to secure them. Note that other forms of mounting may be used, such as, for example, adhesives, rivets, etc. In one embodiment, the height of the L iron bracket acts as standoff.

In one embodiment, each L iron bracket 201 has a handle. FIG. 2B illustrates one embodiment of L iron bracket mounted to base with an attached handle 401. In one embodiment, handles, such as handle 401, are fastened to their respectively L iron bracket using holes and screws. Referring back to FIG. 2A, holes 301 are 0.25-20 holes and are used for fastening a handle using ¼-20 screws. In one embodiment, handle 401 is also secured with Loctite or another well-known adhesive along with the screws. Other well-known forms of fastening may be used to fasten handle 401 to L iron bracket 201.

In one embodiment, the height of the L iron bracket acts as standoff. In other words, the long leg height of L iron bracket 201 is used so the antenna aperture could be flipped. In such a case, L iron brackets maintain the antenna aperture above a surface on which the L iron brackets rest. In one embodiment, in this position, glass substrate layer of the antenna aperture is up while the radome is down and the breakout boards could be engaged/disengaged.

In one embodiment, on top of base plate 10, thumb nuts are coupled to base plate using threaded bolts. The thumb nuts are tightened/loosened to engage/disengage, respectively, clamps hold base plate 10 to the radome fixing the fixture to the aperture. In one embodiment, each clamp has an opening and rotates to hold the radome in its opening to secure the antenna aperture to the retention bracket. At this point, the thumb nuts can be tightened to hold the clamps in place. FIG. 1B also illustrates thumb nuts 210. The clamp is described in more detail below.

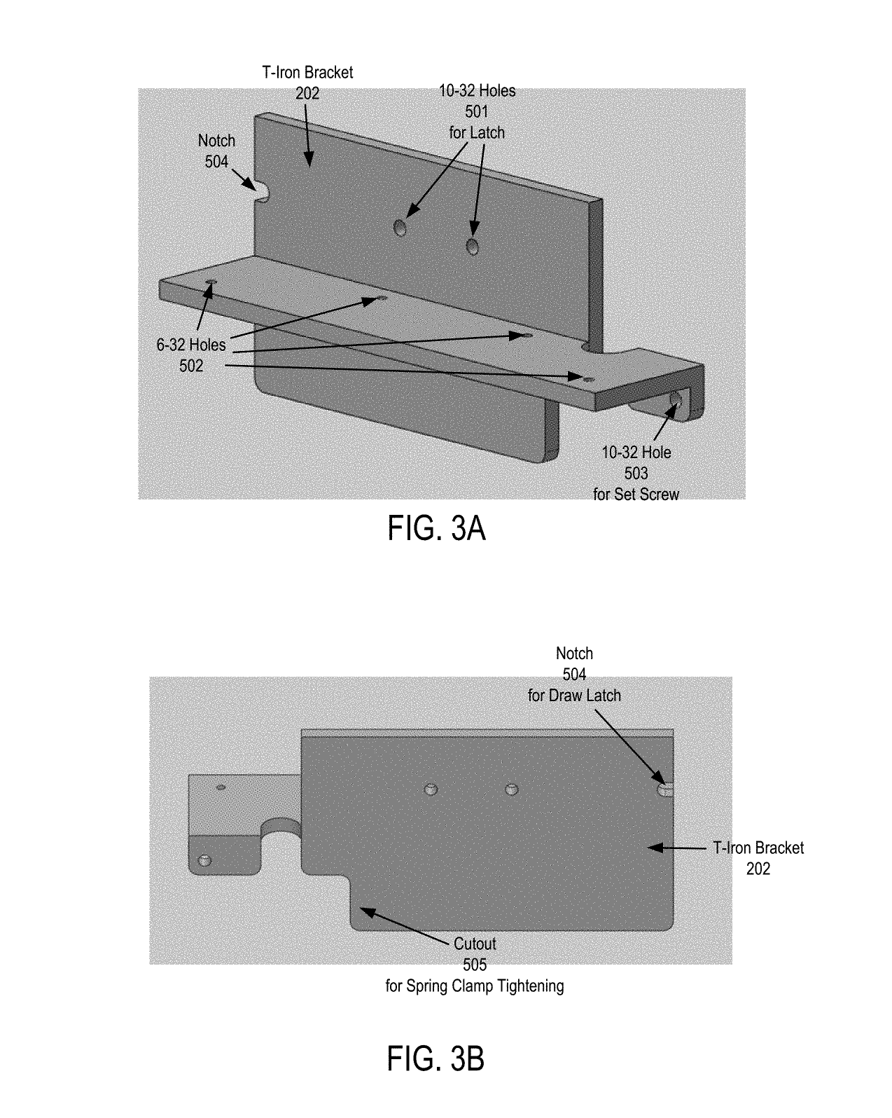

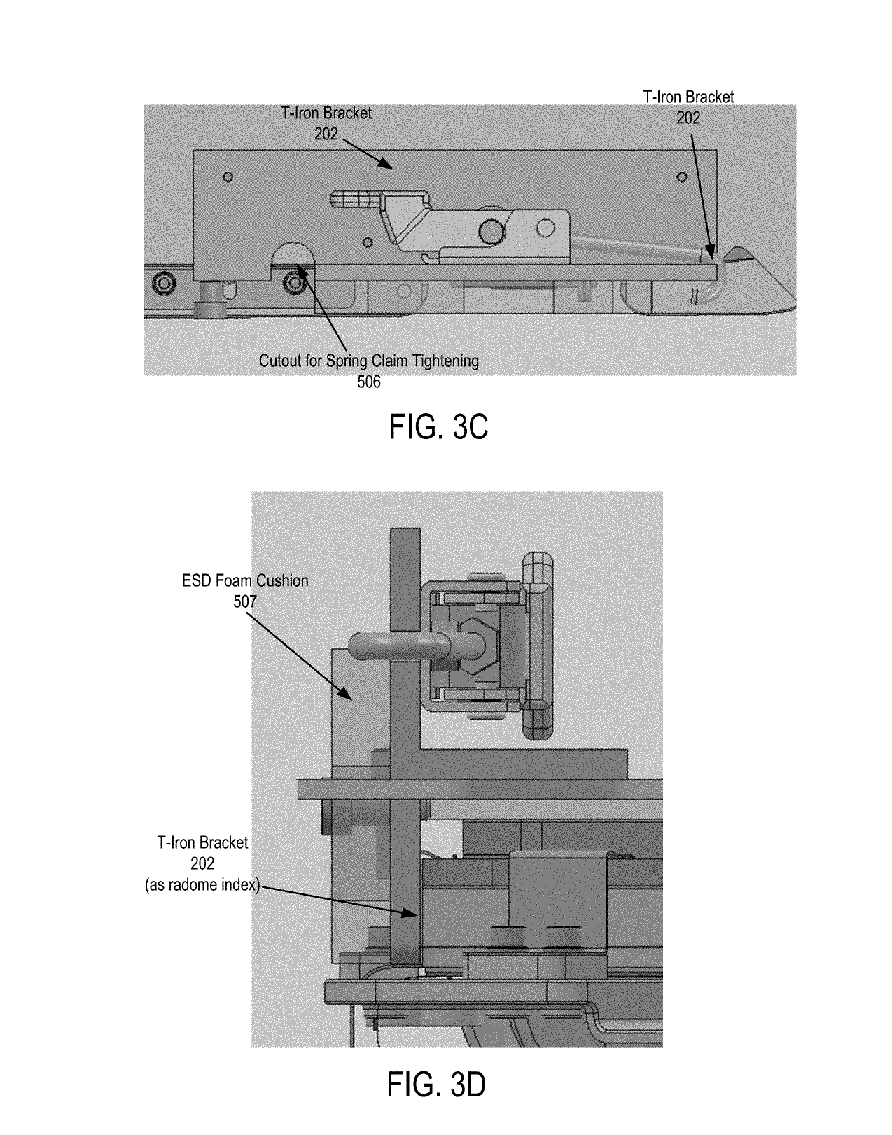

T-Iron brackets 202 are also coupled to base plate 10 as shown in FIG. 1B. In one embodiment, T-Iron bracket 202 has 6-32 threaded holes for mounting to base plate 10. In one embodiment, T-Iron brackets 202 are mounted to base plate 10 using 6-32 screws through the 6-32 threaded holes. In one embodiment, Loctite or another well-known adhesive is used on the screws to secure them. FIG. 3A is a perspective view of one embodiment of a T-Iron mounting and index features, while FIG. 3B illustrates another side of the T-Iron notches and cutouts.

Referring to FIGS. 3A and 3B, T-Iron bracket 202 includes holes 501 to mount a strikeless draw latch. In one embodiment, holes 501 are 10-32 holes to mount the strikeless draw latch. In one embodiment, T-Iron bracket 202 also includes a hole 503 to mount a keeper set screw. In one embodiment, hole 503 is a 10-32 hole. In one embodiment, T-Iron bracket 202 acts as an index around the radome and any wide area impedance matching network attached to the radome. In one embodiment, Loctite is also used on these holes.

In one embodiment, T-Iron bracket 202 has a notch 504 to allow the strikeless draw latch to mate with a removable retainer plate. That is, notch 504 allows the strikeless draw latch to clamp onto a removable retainer plate described below.

In one embodiment, T-Iron bracket 202 has cutouts 505 and 506 to accommodate mounting spring clamps, which are shown in FIGS. 3B and 3C. In one embodiment, T-Iron bracket 202 is machined with cutouts 505 and 506 to accommodate tightening of the spring clamps.

In one embodiment, T-Iron bracket 202 also acts as an index fence for the radome and has ESD foam 507 bonded to it with PSA to clamp/protect (as a cushion) the breakout board as shown in FIG. 3D. ESD foam 507 also holds the breakout board and flex cable in place. This index fence along with the standoff are used to loosely index the fixture to the aperture.

In one embodiment, ESD foam 507 of T-Iron bracket 202 has cutouts that accommodate the large components on the breakout board. In one embodiment, ESD foam 507 is bonded to T-Iron bracket 202 with PSA or another well-known adhesive.

In one embodiment, a shoulder screw screws into T-Iron bracket 202 and is secured with Loctite or another well-known adhesive.

In one embodiment, the strikeless draw latch that is attached to T-Iron bracket 202 is adjusted at assembly so that in firmly engages a removable retainer plate. In one embodiment, the strikeless draw latch is attached to T-Iron bracket 202 with 10-32 screws secured with Loctite or another well-known adhesive.

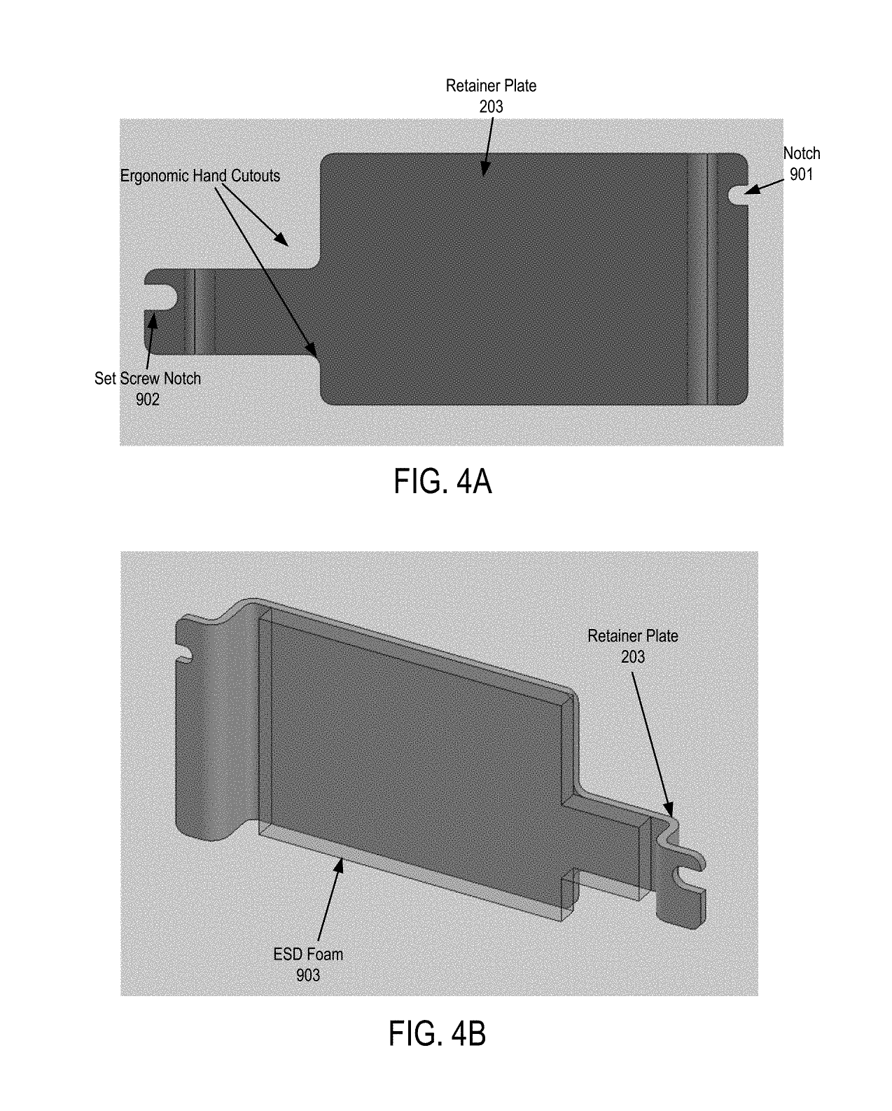

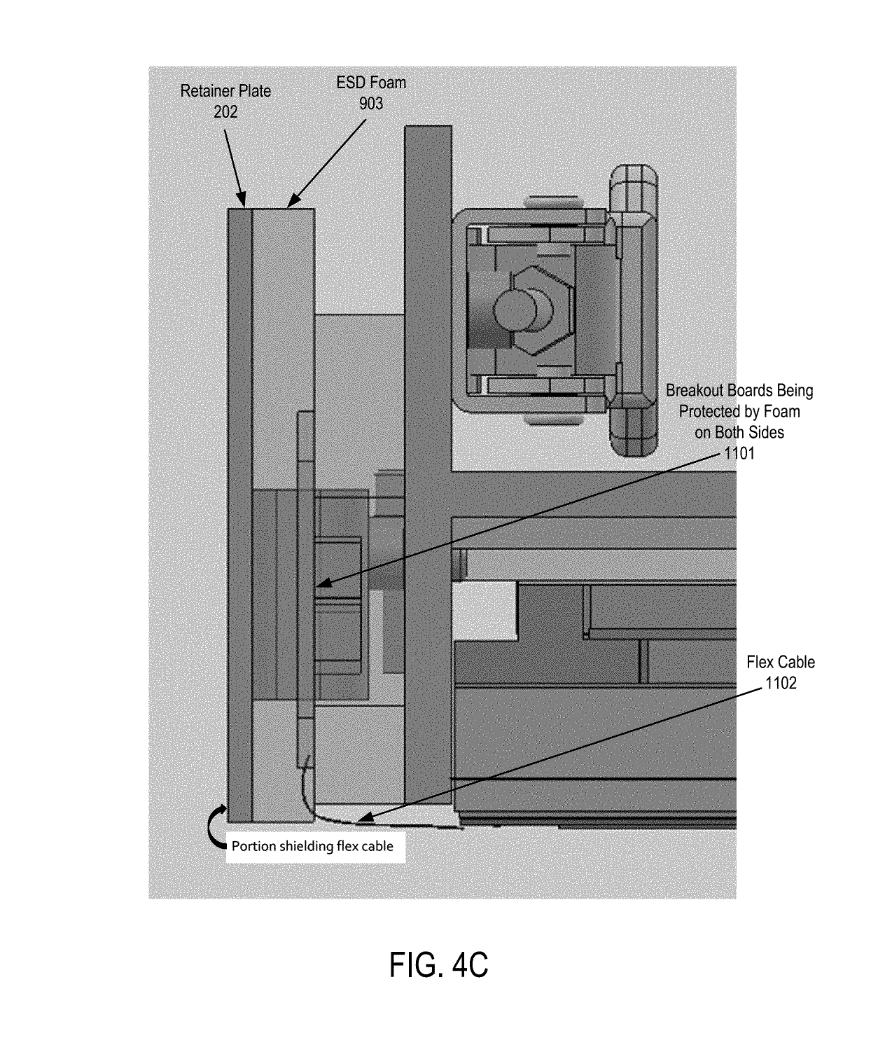

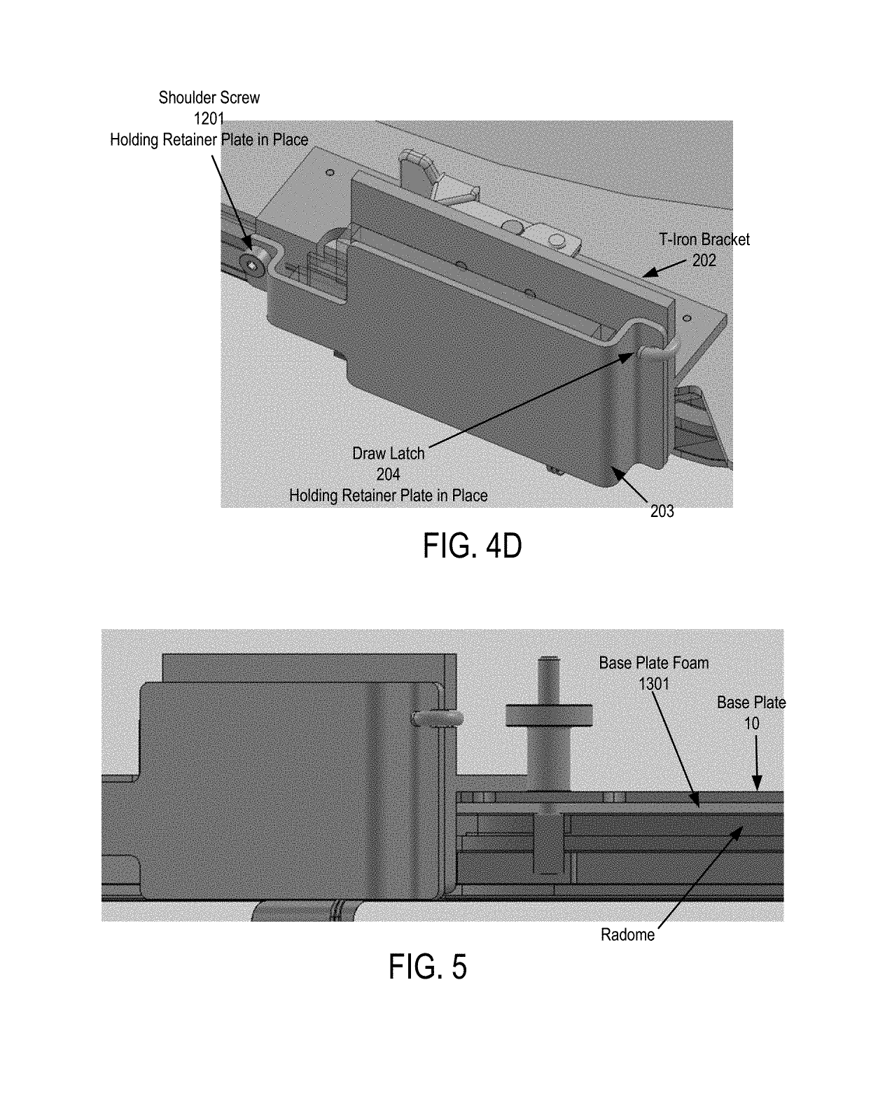

Referring back to FIG. 1B, a retainer plate 203 is coupled to each of T-Iron brackets 202. FIG. 4A illustrates one embodiment of retainer plate 203. In one embodiment, retainer plate 203 has cutouts to accommodate operator's hands for easy installation. In one embodiment, removable retainer plate 203 has a notch 901 to index to the hook of the strikeless draw latch. In one embodiment, removable retainer plate 203 has a notch 902 that indexes to the keeper set screw.

In one embodiment, removable retainer plate 203 also has ESD foam 903 bonded to it to protect the breakout board(s) 1101 as shown in FIGS. 4B and 4C and a portion that acts as a shield for the flex cable 1102 as shown in FIG. 4C. In one embodiment, removable retainer plate 203 is bent to provide cushion of the breakout board/flex cable. In one embodiment, the ESD foam 903 is bonded to the retainer plate 202 with PSA or another well-known adhesive.

Referring back to FIG. 1B, in one embodiment, strikeless draw latch 204 secures retainer plate 202 in place. FIG. 4D illustrates another example of strikeless draw latch 204 securing retainer plate 202 in place. This protects breakout boards and flex cable (as shown in FIG. 4C).

In one embodiment, shoulder screw 1201 retains retainer plate 202 as shown in FIG. 4D.

FIG. 5 illustrates one embodiment of a base plate with ESD cushion foam. Referring to FIG. 5, in one embodiment, ESD foam cushion 1301 attached to base plate 10 protects the radome which abuts at least a portion of the foam cushion 1301 on base plate 10. In one embodiment, the ESD foam cushion 1301 is bonded to the retainer plate 202 with PSA or another well-known adhesive.

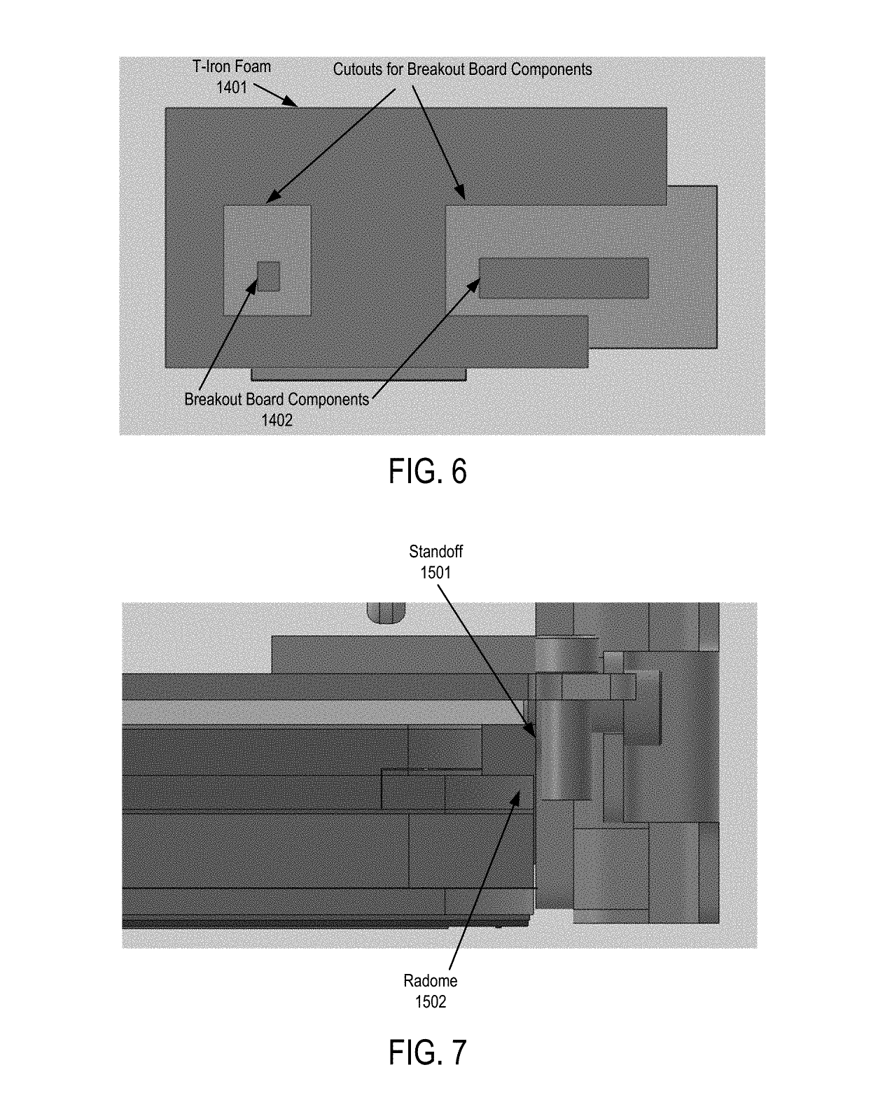

FIG. 6 illustrates one embodiment of ESD foam 1401 to cushion on T-Iron cutouts for breakout board components 1402 and help hold breakout boards in place. In one embodiment, the ESD foam cushion on retainer plate 202 has cutouts to match retainer plate and helps hold breakout boards in place as shown in FIG. 4B. These two cushions work together to hold and protect the breakout boards as shown in FIG. 4C.

FIG. 7 illustrates one embodiment of a standoff. In one embodiment, standoff 1501 acts as index fence for radome 1502.

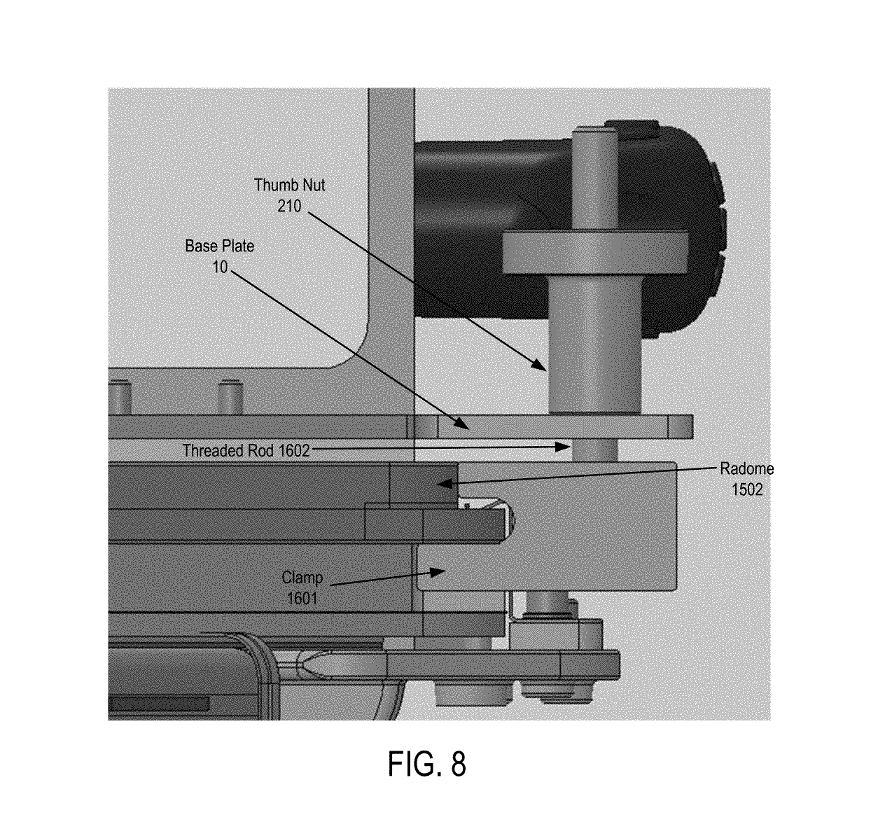

FIG. 8 illustrates one embodiment of radome clamping. Referring to FIG. 8, clamp 1601 is fastened to a threaded rod 1602, which passes through base plate 10 with a thumb nut 210 on the other side to clamp fixture to the radome. In one embodiment, these clamps are free to spin when not tightened by thumb nut 210.

In one embodiment, to use the retention bracket, the operators lower the retention bracket onto a cured antenna aperture on a vacuum fixture or in the automation tray such that T-Iron brackets 202 are aligned with the breakout boards. Removable retainer plates 203 are not in place at this time and the fixture is lowered using the handles. Once the fixture is lowered, the operators engage clamps 1601 with the radome and then tighten thumb nuts 210 to secure the retention bracket to the antenna aperture.

In one embodiment, an operator secures one breakout board at a time as follows. After the retention bracket is secured to the antenna aperture, the operator lifts the breakout board into position on ESD foam 1401 of T-Iron bracket 202, such that the flex cable is in an unstrained position, and holds the breakout board in position with one hand. With the other hand, the operator then places removable retainer plate 203 angled such that shoulder screw notch 902 indexes shoulder screw 1201 while the other side is several inches from T-Iron bracket 202. Once shoulder screw notch 902 is firmly indexed on shoulder screw 1201, the retainer plate 203 is pivoted in place by the operator such that shoulder screw notch 902 in retainer plate 203 and T-Iron bracket 202 align until retainer plate foam 903 holds the breakout board in place and holds retainer plate 203 in place with one hand. The operator releases the breakout board and clamps retainer plate 203 in place with one hand by engaging the hook of strikeless draw latch 204 in notches 901 and 902 in retainer plate 203 and T-Iron bracket 202 and over retainer plate 203 then over-cam the lever of the draw latch 204 securing the breakout boards in place.

In one embodiment, ESD foam on T-Iron bracket 202 and retainer plate 203 compress against each other and the breakout board is secured in place.

In one embodiment, after all breakout boards are secure, the aperture can be lifted from the vacuum table and taken to the coordinate measuring machine (CMM) in one embodiment; alternatively, it is taken to the next manufacturing step. (CMM) where it can be placed upside down (glass substrate up/radome down) on it L-Iron standoffs 1501. In one embodiment, the aperture can then be placed glass down on an antenna feed where the spring clamps that hold the radome to the waveguide can be installed. In one embodiment, the aperture can then be placed glass down on an antenna feed where the spring clamps that hold the radome to the waveguide can be installed. An example of the springs clamps is disclosed in U.S. patent application Ser. No. 15/442,320 entitled “Broadband RF Radial Waveguide Feed with Integrated Glass Transition,” filed Feb. 24, 2017.

After the spring clamps are installed, the antenna with retention bracket attached is flipped upside-down (feed up, aperture down) with the antenna handling device and placed on the L-Iron standoffs 1501 again. The breakout boards are released from the retention bracket in the reverse steps listed above with the antenna upside-down and attached to the feed one at a time. The rest of the electronics and cabling are added to the waveguide, and then this device is loosened while the antenna is upside-down. Then, the antenna is removed from the retention bracket.

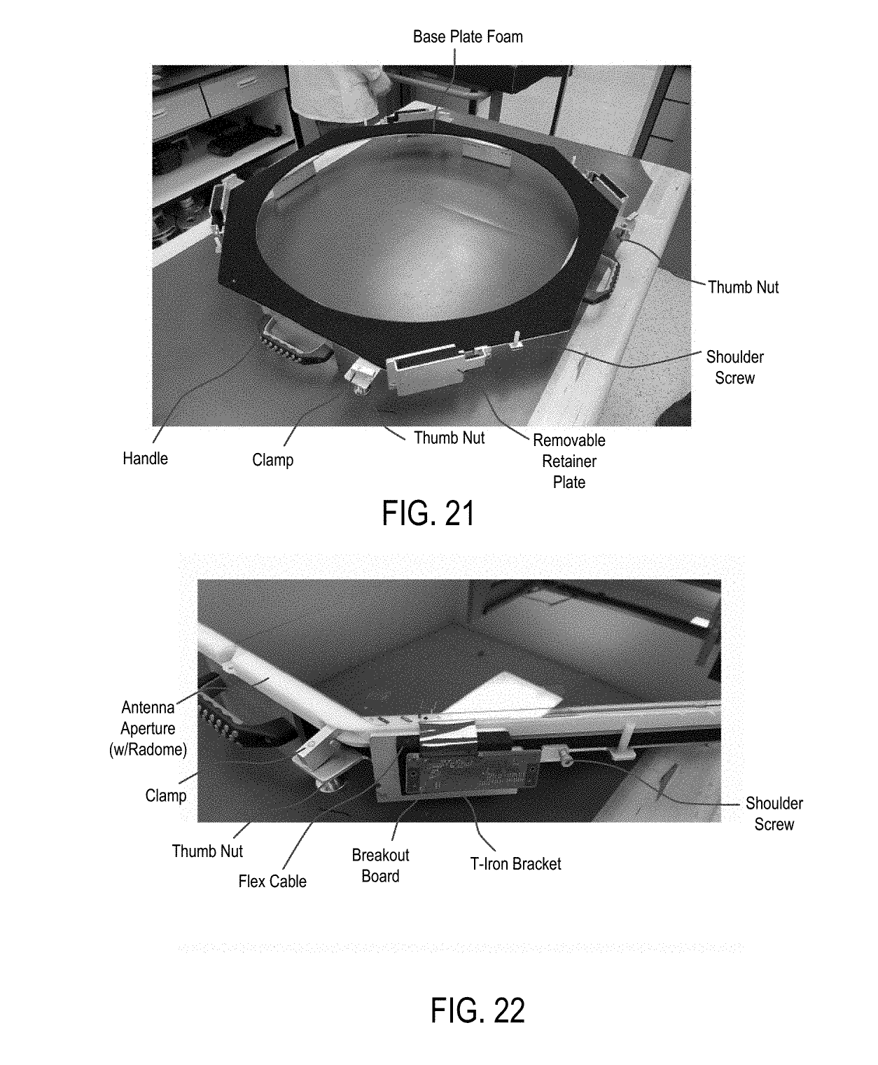

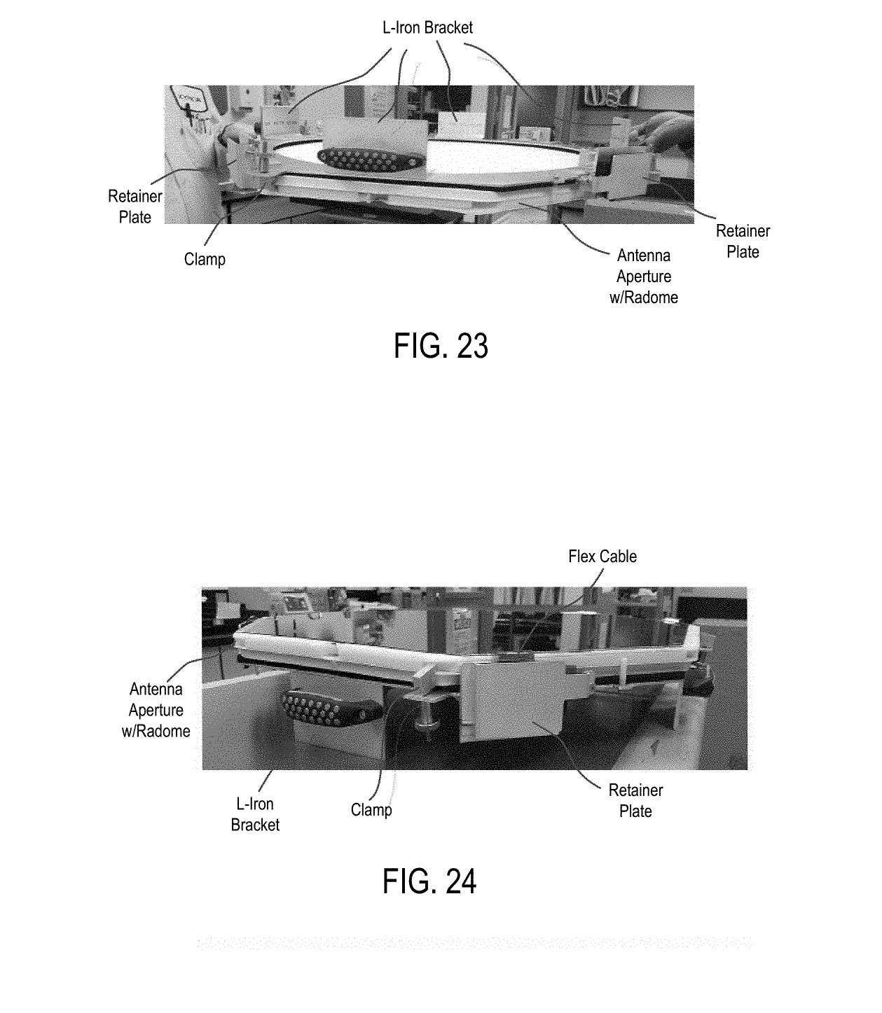

FIG. 21 illustrates one embodiment of the retention bracket without an antenna aperture coupled thereto. FIG. 22 illustrates a portion of one embodiment of the retention bracket with a breakout board attached to an antenna aperture with a flex cable without a retainer plate (uncovered). FIG. 23 illustrates one embodiment of the retention bracket with an antenna aperture coupled thereto and being held with L iron brackets pointing above the antenna aperture. FIG. 24 illustrates an example of one embodiment of the retention bracket with an antenna aperture coupled thereto flipped so that L iron brackets support the retention bracket on a surface.

Embodiments of the retention brackets described above include one or more innovations. These include the following. First, the retention bracket has loose tolerances on it parts such that they are inexpensive to make and easy to assemble. This is monetarily beneficial because use of the retention bracket decreases the amount needed to spend to build out a product the larger the profit margins can be.

Second, the retention bracket uses electro static dissipative (ESD) foam or any other low durometer ESD material to both accommodate the loose part tolerances of this device while at the same time providing secure fixturing for the breakout boards such that the flex connectors are maintained in an unstrained position and to act as a cushion for the painted top of the radome. The former is monetarily beneficial because requiring tight tolerances cost money, so the use of a soft material that does not damage the electronics of an antenna to take up the “left over space” that would be left from using a rigid material with loose tolerances. With respect to the later, the use of ESD foam to act as a cushion for the painted top of the radome protects the antenna by reducing the damage that is caused during the assembly process, which increase profit margins.

Third, the use of removable retainer plates that have ergonomic cutouts to accommodate the operator's hands is advantageous because usability is essential to a tool being worthwhile. If it is difficult to use or cannot accommodate all operators, then there is a greater chance that it will be used incorrectly, which could result in damage to the antenna.

Fourth, the use of rotating strap clamps allows for easy placement of the retention bracket on an aperture and easy engagement of clamps with radome/WAIM. This is important because of the usability of the tool. If attaching the tool to the aperture is difficult or time consuming, then there is a greater risk of operator error because of trying to go too fast or improper installation.

Fifth, the use of a strikeless draw latch in combination with the removable retainer plates mentioned above makes placement and securing of the plates quick and easy with one hand. This is important because the retention bracket is inexpensive with off-the-shelf parts that perform the exact function needed, namely, a repeatable, fast, secure fixturing, that does not require additional design.

Sixth, the spring clamps can be placed and tightened appropriately while the retention bracket is still secured to the aperture assembly. This innovation is important because it allows for a streamline assembly process. In one embodiment, the assembly process comprises: holding an aperture with a retention apparatus by clamping a cover of the aperture, where the aperture is coupled to one or more antenna components, the one or more antenna components securely held in place by the retention apparatus; flipping of the retention apparatus and the aperture while the antenna aperture is held by the retention apparatus and while retaining the one or more antenna components in place; and supporting the retention apparatus on a surface using supports on the retention apparatus to hold the antenna aperture above the surface.

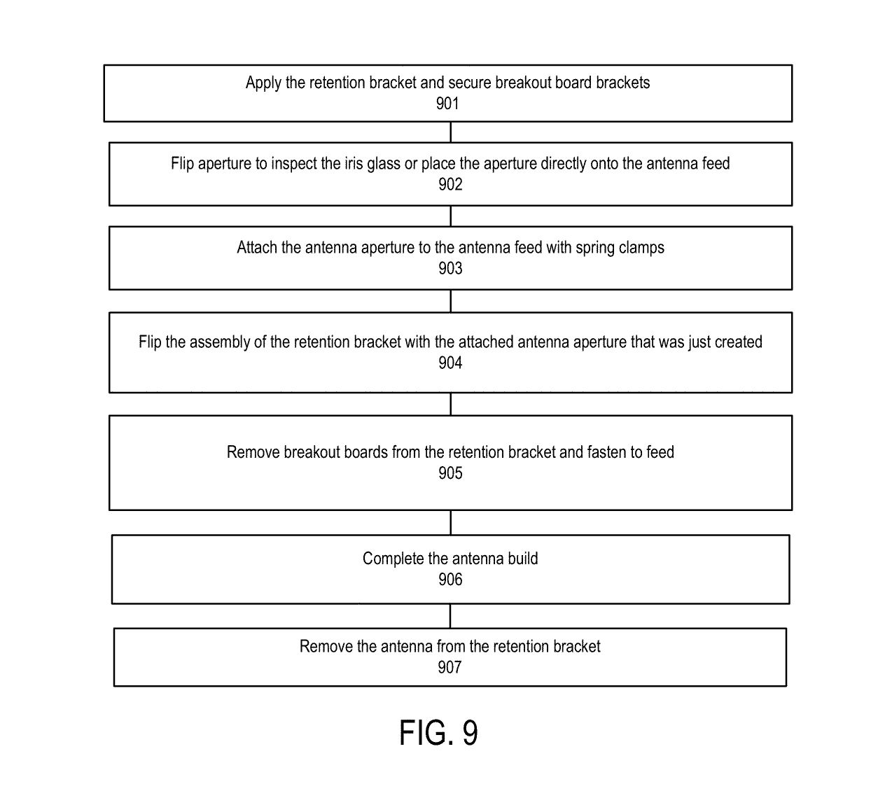

In another embodiment, steps for using the retention bracket include the following: 1) apply the retention bracket and secure breakout board brackets; 2) flip the aperture to inspect the iris glass or place the aperture directly onto the antenna feed; 3) attach the antenna aperture to the antenna feed with spring clamps (all of them in one embodiment); 4) flip the assembly of the retention bracket with the attached antenna aperture that was just created; 5) remove breakout boards from the retention bracket and then fasten them to the feed; 6) complete the antenna build, which includes attach all ancillary parts like the electronics, mechanicals, environmental enclosure; 7) remove the antenna from the retention bracket. FIG. 9 is a flow diagram of one embodiment of such a process. If placement of all spring clamps is not possible in one step, then there would have to be additional steps to remove the retention bracket. Also adding remaining spring clamps increases manufacturing time and complexity, both of which drive up manufacturing costs.

Seventh, the use of standoffs that: 1) allows the aperture to be placed upside down (glass up/radome down) in out CMM to have the elements inspected, which eliminates the need for other fixturing on the CMM for this part; 2) supports the weight of the whole antenna after the aperture is placed on the feed and the two assemblies are combined with spring clamps so the assembly can be flipped upside down while the breakout boards are secured to the feed, which promotes a more streamline assembly with fewer steps to flip the antenna; and 3) allows access to the strikeless draw latch mentioned above so the retainer plates can be removed while the antenna is upside down on top of it, which provides ease of use and simplifies the manufacturing process.

Eighth, the removal of unnecessary material in the center of the fixture to reduce weight and decrease risk of fatigue related injury during use is advantageous because it decreased injuries to operators is another way to decrease the cost of the manufacturing process.

Thus, embodiments of the invention create a safe way to handle apertures, such as segmented thin film transistor (TFT) apertures with breakout boards bonded to rigid carriers, and meets the requirement to support the breakout boards, thereby enabling them to be manipulated during the manufacturing process to manufacture an antenna.

Note that this tool is not limited to being used on antenna apertures and may be used for all segments thin film transistor (TFT) apertures where a flex circuit is bonded between a printed circuit board (PCB) and the TFT segment and the segment is fixed to a carrier.

### Overview of an Example of Antenna Systems

In one embodiment, the flat panel antenna is part of a metamaterial antenna system. Embodiments of a metamaterial antenna system for communications satellite earth stations are described. In one embodiment, the antenna system is a component or subsystem of a satellite earth station (ES) operating on a mobile platform (e.g., aeronautical, maritime, land, etc.) that operates using either Ka-band frequencies or Ku-band frequencies for civil commercial satellite communications. Note that embodiments of the antenna system also can be used in earth stations that are not on mobile platforms (e.g., fixed or transportable earth stations).

In one embodiment, the antenna system uses surface scattering metamaterial technology to form and steer transmit and receive beams through separate antennas. In one embodiment, the antenna systems are analog systems, in contrast to antenna systems that employ digital signal processing to electrically form and steer beams (such as phased array antennas).

In one embodiment, the antenna system is comprised of three functional subsystems: (1) a wave guiding structure consisting of a cylindrical wave feed architecture; (2) an array of wave scattering metamaterial unit cells that are part of antenna elements; and (3) a control structure to command formation of an adjustable radiation field (beam) from the metamaterial scattering elements using holographic principles.

### Antenna Elements

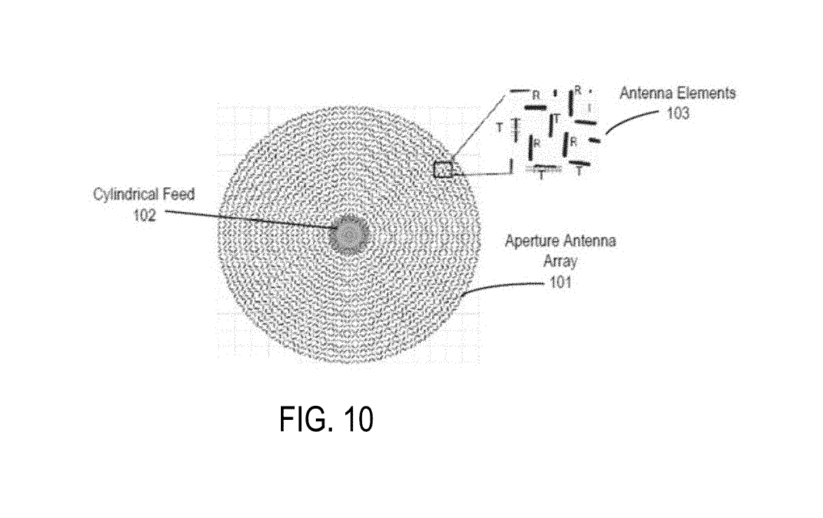

FIG. 10 illustrates the schematic of one embodiment of a cylindrically fed holographic radial aperture antenna. Referring to FIG. 10, the antenna aperture has one or more arrays 101 of antenna elements 103 that are placed in concentric rings around an input feed 102 of the cylindrically fed antenna. In one embodiment, antenna elements 103 are radio frequency (RF) resonators that radiate RF energy. In one embodiment, antenna elements 103 comprise both Rx and Tx irises that are interleaved and distributed on the whole surface of the antenna aperture. Examples of such antenna elements are described in greater detail below. Note that the RF resonators described herein may be used in antennas that do not include a cylindrical feed.

In one embodiment, the antenna includes a coaxial feed that is used to provide a cylindrical wave feed via input feed 102. In one embodiment, the cylindrical wave feed architecture feeds the antenna from a central point with an excitation that spreads outward in a cylindrical manner from the feed point. That is, a cylindrically fed antenna creates an outward travelling concentric feed wave. Even so, the shape of the cylindrical feed antenna around the cylindrical feed can be circular, square or any shape. In another embodiment, a cylindrically fed antenna creates an inward travelling feed wave. In such a case, the feed wave most naturally comes from a circular structure.

In one embodiment, antenna elements 103 comprise irises and the aperture antenna of FIG. 10 is used to generate a main beam shaped by using excitation from a cylindrical feed wave for radiating irises through tunable liquid crystal (LC) material. In one embodiment, the antenna can be excited to radiate a horizontally or vertically polarized electric field at desired scan angles.

In one embodiment, the antenna elements comprise a group of patch antennas. This group of patch antennas comprises an array of scattering metamaterial elements. In one embodiment, each scattering element in the antenna system is part of a unit cell that consists of a lower conductor, a dielectric substrate and an upper conductor that embeds a complementary electric inductive-capacitive resonator (“complementary electric LC” or “CELL”) that is etched in or deposited onto the upper conductor. As would be understood by those skilled in the art, LC in the context of CELC refers to inductance-capacitance, as opposed to liquid crystal.

In one embodiment, a liquid crystal (LC) is disposed in the gap around the scattering element. This LC is driven by the direct drive embodiments described above. In one embodiment, liquid crystal is encapsulated in each unit cell and separates the lower conductor associated with a slot from an upper conductor associated with its patch. Liquid crystal has a permittivity that is a function of the orientation of the molecules comprising the liquid crystal, and the orientation of the molecules (and thus the permittivity) can be controlled by adjusting the bias voltage across the liquid crystal. Using this property, in one embodiment, the liquid crystal integrates an on/off switch for the transmission of energy from the guided wave to the CELC. When switched on, the CELC emits an electromagnetic wave like an electrically small dipole antenna. Note that the teachings herein are not limited to having a liquid crystal that operates in a binary fashion with respect to energy transmission.

In one embodiment, the feed geometry of this antenna system allows the antenna elements to be positioned at forty five degree (45°) angles to the vector of the wave in the wave feed. Note that other positions may be used (e.g., at 40° angles). This position of the elements enables control of the free space wave received by or transmitted/radiated from the elements. In one embodiment, the antenna elements are arranged with an inter-element spacing that is less than a free-space wavelength of the operating frequency of the antenna. For example, if there are four scattering elements per wavelength, the elements in the 30 GHz transmit antenna will be approximately 2.5 mm (i.e., ¼th the 10 mm free-space wavelength of 30 GHz).

In one embodiment, the two sets of elements are perpendicular to each other and simultaneously have equal amplitude excitation if controlled to the same tuning state. Rotating them +/−45 degrees relative to the feed wave excitation achieves both desired features at once. Rotating one set 0 degrees and the other 90 degrees would achieve the perpendicular goal, but not the equal amplitude excitation goal. Note that 0 and 90 degrees may be used to achieve isolation when feeding the array of antenna elements in a single structure from two sides.

The amount of radiated power from each unit cell is controlled by applying a voltage to the patch (potential across the LC channel) using a controller. Traces to each patch are used to provide the voltage to the patch antenna. The voltage is used to tune or detune the capacitance and thus the resonance frequency of individual elements to effectuate beam forming. The voltage required is dependent on the liquid crystal mixture being used. The voltage tuning characteristic of liquid crystal mixtures is mainly described by a threshold voltage at which the liquid crystal starts to be affected by the voltage and the saturation voltage, above which an increase of the voltage does not cause major tuning in liquid crystal. These two characteristic parameters can change for different liquid crystal mixtures.

In one embodiment, as discussed above, a matrix drive is used to apply voltage to the patches in order to drive each cell separately from all the other cells without having a separate connection for each cell (direct drive). Because of the high density of elements, the matrix drive is an efficient way to address each cell individually.

In one embodiment, the control structure for the antenna system has 2 main components: the antenna array controller, which includes drive electronics, for the antenna system, is below the wave scattering structure, while the matrix drive switching array is interspersed throughout the radiating RF array in such a way as to not interfere with the radiation. In one embodiment, the drive electronics for the antenna system comprise commercial off-the shelf LCD controls used in commercial television appliances that adjust the bias voltage for each scattering element by adjusting the amplitude or duty cycle of an AC bias signal to that element.

In one embodiment, the antenna array controller also contains a microprocessor executing the software. The control structure may also incorporate sensors (e.g., a GPS receiver, a three axis compass, a 3-axis accelerometer, 3-axis gyro, 3-axis magnetometer, etc.) to provide location and orientation information to the processor. The location and orientation information may be provided to the processor by other systems in the earth station and/or may not be part of the antenna system.

More specifically, the antenna array controller controls which elements are turned off and those elements turned on and at which phase and amplitude level at the frequency of operation. The elements are selectively detuned for frequency operation by voltage application.

For transmission, a controller supplies an array of voltage signals to the RF patches to create a modulation, or control pattern. The control pattern causes the elements to be turned to different states. In one embodiment, multistate control is used in which various elements are turned on and off to varying levels, further approximating a sinusoidal control pattern, as opposed to a square wave (i.e., a sinusoid gray shade modulation pattern). In one embodiment, some elements radiate more strongly than others, rather than some elements radiate and some do not. Variable radiation is achieved by applying specific voltage levels, which adjusts the liquid crystal permittivity to varying amounts, thereby detuning elements variably and causing some elements to radiate more than others.

The generation of a focused beam by the metamaterial array of elements can be explained by the phenomenon of constructive and destructive interference. Individual electromagnetic waves sum up (constructive interference) if they have the same phase when they meet in free space and waves cancel each other (destructive interference) if they are in opposite phase when they meet in free space. If the slots in a slotted antenna are positioned so that each successive slot is positioned at a different distance from the excitation point of the guided wave, the scattered wave from that element will have a different phase than the scattered wave of the previous slot. If the slots are spaced one quarter of a guided wavelength apart, each slot will scatter a wave with a one fourth phase delay from the previous slot.

Using the array, the number of patterns of constructive and destructive interference that can be produced can be increased so that beams can be pointed theoretically in any direction plus or minus ninety degrees (90°) from the bore sight of the antenna array, using the principles of holography. Thus, by controlling which metamaterial unit cells are turned on or off (i.e., by changing the pattern of which cells are turned on and which cells are turned off), a different pattern of constructive and destructive interference can be produced, and the antenna can change the direction of the main beam. The time required to turn the unit cells on and off dictates the speed at which the beam can be switched from one location to another location.

In one embodiment, the antenna system produces one steerable beam for the uplink antenna and one steerable beam for the downlink antenna. In one embodiment, the antenna system uses metamaterial technology to receive beams and to decode signals from the satellite and to form transmit beams that are directed toward the satellite. In one embodiment, the antenna systems are analog systems, in contrast to antenna systems that employ digital signal processing to electrically form and steer beams (such as phased array antennas). In one embodiment, the antenna system is considered a “surface” antenna that is planar and relatively low profile, especially when compared to conventional satellite dish receivers.

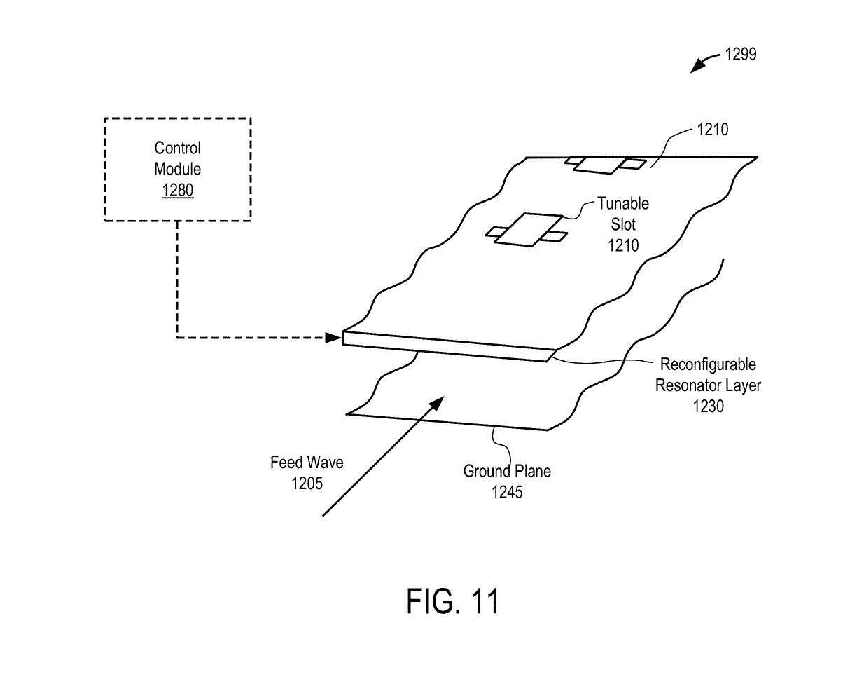

FIG. 11 illustrates a perspective view of one row of antenna elements that includes a ground plane and a reconfigurable resonator layer. Reconfigurable resonator layer 1230 includes an array of tunable slots 1210. The array of tunable slots 1210 can be configured to point the antenna in a desired direction. Each of the tunable slots can be tuned/adjusted by varying a voltage across the liquid crystal.

Control module 1280 is coupled to reconfigurable resonator layer 1230 to modulate the array of tunable slots 1210 by varying the voltage across the liquid crystal in FIG. 11. Control module 1280 may include a Field Programmable Gate Array (“FPGA”), a microprocessor, a controller, System-on-a-Chip (SoC), or other processing logic. In one embodiment, control module 1280 includes logic circuitry (e.g., multiplexer) to drive the array of tunable slots 1210. In one embodiment, control module 1280 receives data that includes specifications for a holographic diffraction pattern to be driven onto the array of tunable slots 1210. The holographic diffraction patterns may be generated in response to a spatial relationship between the antenna and a satellite so that the holographic diffraction pattern steers the downlink beams (and uplink beam if the antenna system performs transmit) in the appropriate direction for communication. Although not drawn in each figure, a control module similar to control module 1280 may drive each array of tunable slots described in the figures of the disclosure.

Radio Frequency (“RF”) holography is also possible using analogous techniques where a desired RF beam can be generated when an RF reference beam encounters an RF holographic diffraction pattern. In the case of satellite communications, the reference beam is in the form of a feed wave, such as feed wave 1205 (approximately 20 GHz in some embodiments). To transform a feed wave into a radiated beam (either for transmitting or receiving purposes), an interference pattern is calculated between the desired RF beam (the object beam) and the feed wave (the reference beam). The interference pattern is driven onto the array of tunable slots 1210 as a diffraction pattern so that the feed wave is “steered” into the desired RF beam (having the desired shape and direction). In other words, the feed wave encountering the holographic diffraction pattern “reconstructs” the object beam, which is formed according to design requirements of the communication system. The holographic diffraction pattern contains the excitation of each element and is calculated by W_{hologram}=Wᵢₙ^{*}Wₒᵤₜ, with Wᵢₙ as the wave equation in the waveguide and Wₒᵤₜ the wave equation on the outgoing wave.

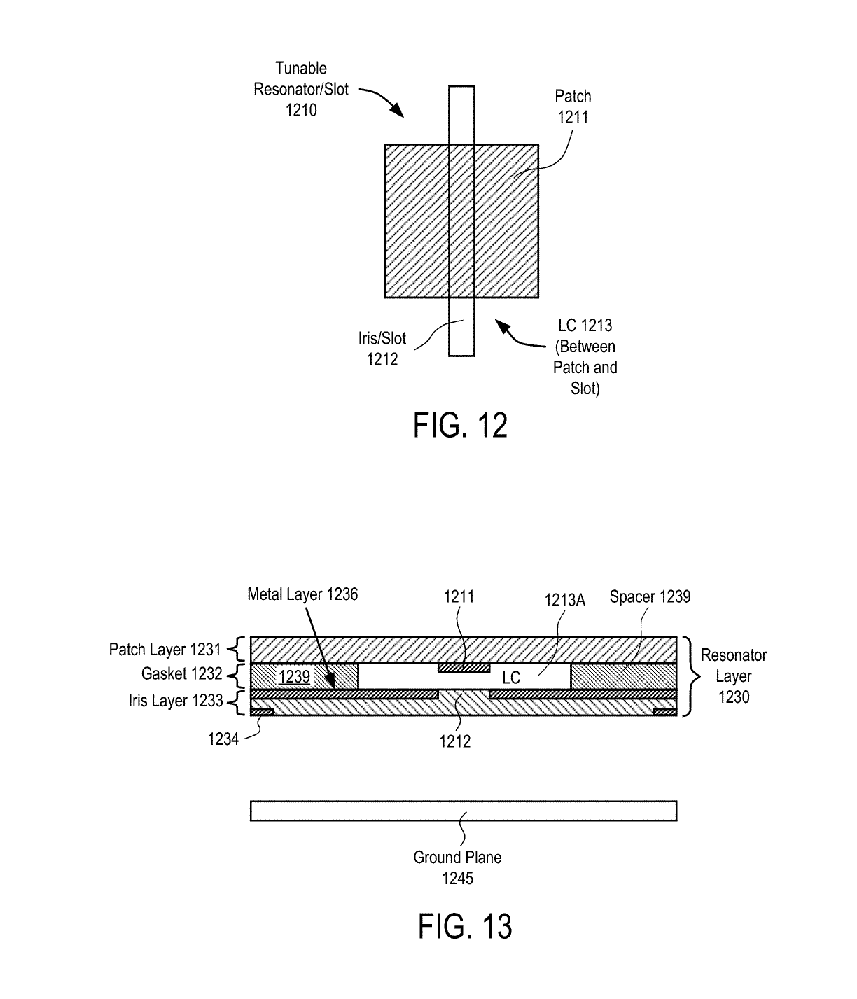

FIG. 12 illustrates one embodiment of a tunable resonator/slot 1210. Tunable slot 1210 includes an iris/slot 1212, a radiating patch 1211, and liquid crystal 1213 disposed between iris 1212 and patch 1211. In one embodiment, radiating patch 1211 is co-located with iris 1212.

FIG. 13 illustrates a cross section view of one embodiment of a physical antenna aperture. The antenna aperture includes ground plane 1245, and a metal layer 1236 within iris layer 1233, which is included in reconfigurable resonator layer 1230. In one embodiment, the antenna aperture of FIG. 13 includes a plurality of tunable resonator/slots 1210 of FIG. 12. Iris/slot 1212 is defined by openings in metal layer 1236. A feed wave, such as feed wave 1205 of FIG. 11, may have a microwave frequency compatible with satellite communication channels. The feed wave propagates between ground plane 1245 and resonator layer 1230.

Reconfigurable resonator layer 1230 also includes gasket layer 1232 and patch layer 1231. Gasket layer 1232 is disposed between patch layer 1231 and iris layer 1233. Note that in one embodiment, a spacer could replace gasket layer 1232. In one embodiment, iris layer 1233 is a printed circuit board (“PCB”) that includes a copper layer as metal layer 1236. In one embodiment, iris layer 1233 is glass. Iris layer 1233 may be other types of substrates.

Openings may be etched in the copper layer to form slots 1212. In one embodiment, iris layer 1233 is conductively coupled by a conductive bonding layer to another structure (e.g., a waveguide) in FIG. 13. Note that in an embodiment the iris layer is not conductively coupled by a conductive bonding layer and is instead interfaced with a non-conducting bonding layer.

Patch layer 1231 may also be a PCB that includes metal as radiating patches 1211. In one embodiment, gasket layer 1232 includes spacers 1239 that provide a mechanical standoff to define the dimension between metal layer 1236 and patch 1211. In one embodiment, the spacers are 75 microns, but other sizes may be used (e.g., 3-200 mm). As mentioned above, in one embodiment, the antenna aperture of FIG. 13 includes multiple tunable resonator/slots, such as tunable resonator/slot 1210 includes patch 1211, liquid crystal 1213, and iris 1212 of FIG. 12. The chamber for liquid crystal 1213 is defined by spacers 1239, iris layer 1233 and metal layer 1236. When the chamber is filled with liquid crystal, patch layer 1231 can be laminated onto spacers 1239 to seal liquid crystal within resonator layer 1230.

A voltage between patch layer 1231 and iris layer 1233 can be modulated to tune the liquid crystal in the gap between the patch and the slots (e.g., tunable resonator/slot 1210). Adjusting the voltage across liquid crystal 1213 varies the capacitance of a slot (e.g., tunable resonator/slot 1210). Accordingly, the reactance of a slot (e.g., tunable resonator/slot 1210) can be varied by changing the capacitance. Resonant frequency of slot 1210 also changes according to the equation

$$f = \frac{1}{2 π \sqrt{LC}}$$

where f is the resonant frequency of slot 1210 and L and C are the inductance and capacitance of slot 1210, respectively. The resonant frequency of slot 1210 affects the energy radiated from feed wave 1205 propagating through the waveguide. As an example, if feed wave 1205 is 20 GHz, the resonant frequency of a slot 1210 may be adjusted (by varying the capacitance) to 17 GHz so that the slot 1210 couples substantially no energy from feed wave 1205. Or, the resonant frequency of a slot 1210 may be adjusted to 20 GHz so that the slot 1210 couples energy from feed wave 1205 and radiates that energy into free space. Although the examples given are binary (fully radiating or not radiating at all), full gray scale control of the reactance, and therefore the resonant frequency of slot 1210 is possible with voltage variance over a multi-valued range. Hence, the energy radiated from each slot 1210 can be finely controlled so that detailed holographic diffraction patterns can be formed by the array of tunable slots.

In one embodiment, tunable slots in a row are spaced from each other by λ/5. Other spacings may be used. In one embodiment, each tunable slot in a row is spaced from the closest tunable slot in an adjacent row by λ/2, and, thus, commonly oriented tunable slots in different rows are spaced by λ/4, though other spacings are possible (e.g., λ/5, λ/6.3). In another embodiment, each tunable slot in a row is spaced from the closest tunable slot in an adjacent row by λ/3.

Embodiments use reconfigurable metamaterial technology, such as described in U.S. patent application Ser. No. 14/550,178, entitled “Dynamic Polarization and Coupling Control from a Steerable Cylindrically Fed Holographic Antenna”, filed Nov. 21, 2014 and U.S. patent application Ser. No. 14/610,502, entitled “Ridged Waveguide Feed Structures for Reconfigurable Antenna”, filed Jan. 30, 2015.

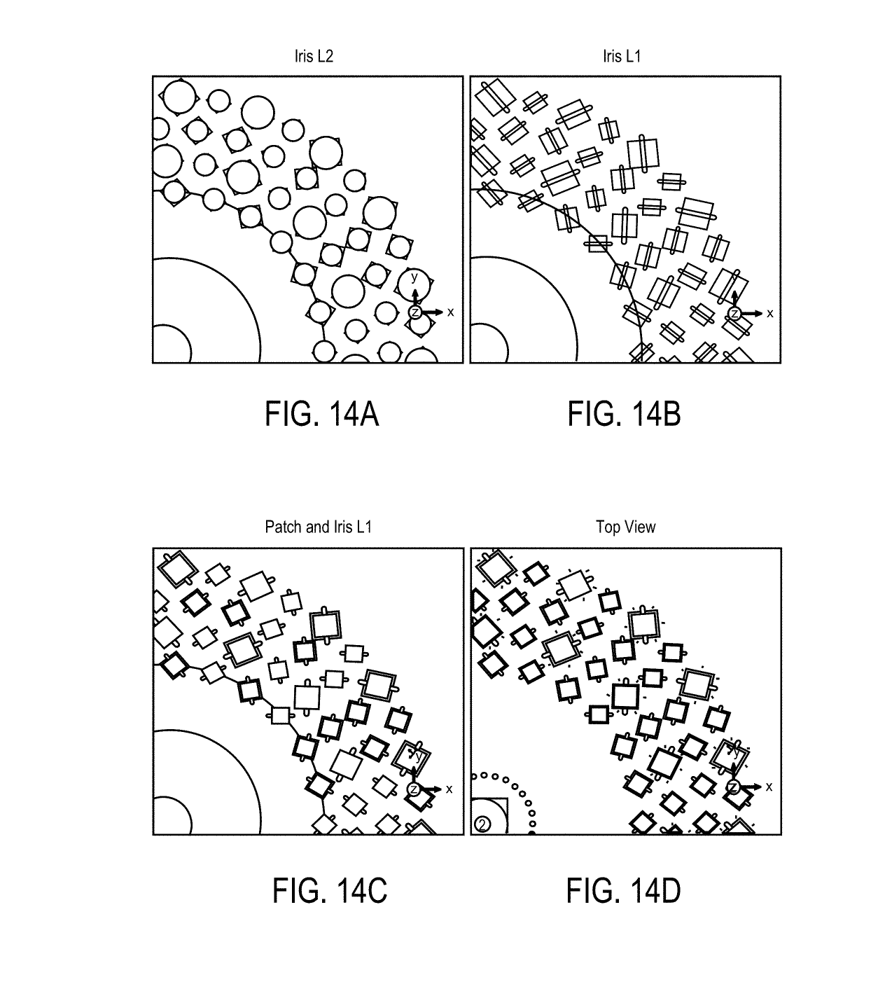

FIGS. 14A-D illustrate one embodiment of the different layers for creating the slotted array. The antenna array includes antenna elements that are positioned in rings, such as the example rings shown in FIG. 10. Note that in this example the antenna array has two different types of antenna elements that are used for two different types of frequency bands.

FIG. 14A illustrates a portion of the first iris board layer with locations corresponding to the slots. Referring to FIG. 14A, the circles are open areas/slots in the metallization in the bottom side of the iris substrate, and are for controlling the coupling of elements to the feed (the feed wave). Note that this layer is an optional layer and is not used in all designs. FIG. 14B illustrates a portion of the second iris board layer containing slots. FIG. 14C illustrates patches over a portion of the second iris board layer. FIG. 14D illustrates a top view of a portion of the slotted array.

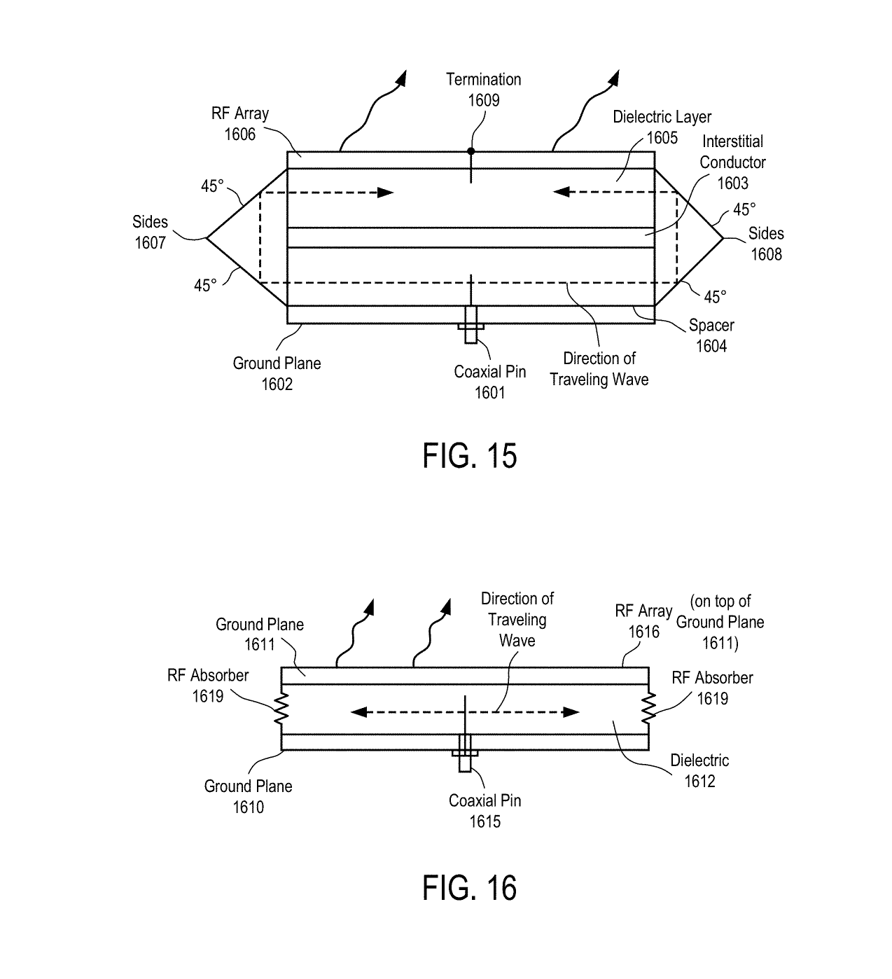

FIG. 15 illustrates a side view of one embodiment of a cylindrically fed antenna structure. The antenna produces an inwardly travelling wave using a double layer feed structure (i.e., two layers of a feed structure). In one embodiment, the antenna includes a circular outer shape, though this is not required. That is, non-circular inward travelling structures can be used. In one embodiment, the antenna structure in FIG. 15 includes the coaxial feed of FIG. 9.

Referring to FIG. 15, a coaxial pin 1601 is used to excite the field on the lower level of the antenna. In one embodiment, coaxial pin 1601 is a 50Ω coax pin that is readily available. Coaxial pin 1601 is coupled (e.g., bolted) to the bottom of the antenna structure, which is conducting ground plane 1602.

Separate from conducting ground plane 1602 is interstitial conductor 1603, which is an internal conductor. In one embodiment, conducting ground plane 1602 and interstitial conductor 1603 are parallel to each other. In one embodiment, the distance between ground plane 1602 and interstitial conductor 1603 is 0.1-0.15″. In another embodiment, this distance may be λ/2, where λ is the wavelength of the travelling wave at the frequency of operation.

Ground plane 1602 is separated from interstitial conductor 1603 via a spacer 1604. In one embodiment, spacer 1604 is a foam or air-like spacer. In one embodiment, spacer 1604 comprises a plastic spacer.

On top of interstitial conductor 1603 is dielectric layer 1605. In one embodiment, dielectric layer 1605 is plastic. The purpose of dielectric layer 1605 is to slow the travelling wave relative to free space velocity. In one embodiment, dielectric layer 1605 slows the travelling wave by 30% relative to free space. In one embodiment, the range of indices of refraction that are suitable for beam forming are 1.2-1.8, where free space has by definition an index of refraction equal to 1. Other dielectric spacer materials, such as, for example, plastic, may be used to achieve this effect. Note that materials other than plastic may be used as long as they achieve the desired wave slowing effect. Alternatively, a material with distributed structures may be used as dielectric 1605, such as periodic sub-wavelength metallic structures that can be machined or lithographically defined, for example.

An RF-array 1606 is on top of dielectric 1605. In one embodiment, the distance between interstitial conductor 1603 and RF-array 1606 is 0.1-0.15″. In another embodiment, this distance may be λ_{eff}/2, where λ_{eff} is the effective wavelength in the medium at the design frequency.

The antenna includes sides 1607 and 1608. Sides 1607 and 1608 are angled to cause a travelling wave feed from coax pin 1601 to be propagated from the area below interstitial conductor 1603 (the spacer layer) to the area above interstitial conductor 1603 (the dielectric layer) via reflection. In one embodiment, the angle of sides 1607 and 1608 are at 45° angles. In an alternative embodiment, sides 1607 and 1608 could be replaced with a continuous radius to achieve the reflection. While FIG. 15 shows angled sides that have angle of 45 degrees, other angles that accomplish signal transmission from lower level feed to upper level feed may be used. That is, given that the effective wavelength in the lower feed will generally be different than in the upper feed, some deviation from the ideal 45° angles could be used to aid transmission from the lower to the upper feed level. For example, in another embodiment, the 45° angles are replaced with a single step. The steps on one end of the antenna go around the dielectric layer, interstitial the conductor, and the spacer layer. The same two steps are at the other ends of these layers.

In operation, when a feed wave is fed in from coaxial pin 1601, the wave travels outward concentrically oriented from coaxial pin 1601 in the area between ground plane 1602 and interstitial conductor 1603. The concentrically outgoing waves are reflected by sides 1607 and 1608 and travel inwardly in the area between interstitial conductor 1603 and RF array 1606. The reflection from the edge of the circular perimeter causes the wave to remain in phase (i.e., it is an in-phase reflection). The travelling wave is slowed by dielectric layer 1605. At this point, the travelling wave starts interacting and exciting with elements in RF array 1606 to obtain the desired scattering.

To terminate the travelling wave, a termination 1609 is included in the antenna at the geometric center of the antenna. In one embodiment, termination 1609 comprises a pin termination (e.g., a 50Ω pin). In another embodiment, termination 1609 comprises an RF absorber that terminates unused energy to prevent reflections of that unused energy back through the feed structure of the antenna. These could be used at the top of RF array 1606.

FIG. 16 illustrates another embodiment of the antenna system with an outgoing wave. Referring to FIG. 16, two ground planes 1610 and 1611 are substantially parallel to each other with a dielectric layer 1612 (e.g., a plastic layer, etc.) in between ground planes. RF absorbers 1619 (e.g., resistors) couple the two ground planes 1610 and 1611 together. A coaxial pin 1615 (e.g., 50Ω) feeds the antenna. An RF array 1616 is on top of dielectric layer 1612 and ground plane 1611.

In operation, a feed wave is fed through coaxial pin 1615 and travels concentrically outward and interacts with the elements of RF array 1616.

The cylindrical feed in both the antennas of FIGS. 15 and 16 improves the service angle of the antenna. Instead of a service angle of plus or minus forty five degrees azimuth (±45° Az) and plus or minus twenty five degrees elevation (±25° El), in one embodiment, the antenna system has a service angle of seventy five degrees (75°) from the bore sight in all directions. As with any beam forming antenna comprised of many individual radiators, the overall antenna gain is dependent on the gain of the constituent elements, which themselves are angle-dependent. When using common radiating elements, the overall antenna gain typically decreases as the beam is pointed further off bore sight. At 75 degrees off bore sight, significant gain degradation of about 6 dB is expected.

Embodiments of the antenna having a cylindrical feed solve one or more problems. These include dramatically simplifying the feed structure compared to antennas fed with a corporate divider network and therefore reducing total required antenna and antenna feed volume; decreasing sensitivity to manufacturing and control errors by maintaining high beam performance with coarser controls (extending all the way to simple binary control); giving a more advantageous side lobe pattern compared to rectilinear feeds because the cylindrically oriented feed waves result in spatially diverse side lobes in the far field; and allowing polarization to be dynamic, including allowing left-hand circular, right-hand circular, and linear polarizations, while not requiring a polarizer.

### Array of Wave Scattering Elements

RF array 1606 of FIG. 15 and RF array 1616 of FIG. 16 include a wave scattering subsystem that includes a group of patch antennas (i.e., scatterers) that act as radiators. This group of patch antennas comprises an array of scattering metamaterial elements.

In one embodiment, each scattering element in the antenna system is part of a unit cell that consists of a lower conductor, a dielectric substrate and an upper conductor that embeds a complementary electric inductive-capacitive resonator (“complementary electric LC” or “CELC”) that is etched in or deposited onto the upper conductor.

In one embodiment, a liquid crystal (LC) is injected in the gap around the scattering element. Liquid crystal is encapsulated in each unit cell and separates the lower conductor associated with a slot from an upper conductor associated with its patch. Liquid crystal has a permittivity that is a function of the orientation of the molecules comprising the liquid crystal, and the orientation of the molecules (and thus the permittivity) can be controlled by adjusting the bias voltage across the liquid crystal. Using this property, the liquid crystal acts as an on/off switch for the transmission of energy from the guided wave to the CELC. When switched on, the CELC emits an electromagnetic wave like an electrically small dipole antenna.

Controlling the thickness of the LC increases the beam switching speed. A fifty percent (50%) reduction in the gap between the lower and the upper conductor (the thickness of the liquid crystal) results in a fourfold increase in speed. In another embodiment, the thickness of the liquid crystal results in a beam switching speed of approximately fourteen milliseconds (14 ms). In one embodiment, the LC is doped in a manner well-known in the art to improve responsiveness so that a seven millisecond (7 ms) requirement can be met.

The CELC element is responsive to a magnetic field that is applied parallel to the plane of the CELC element and perpendicular to the CELC gap complement. When a voltage is applied to the liquid crystal in the metamaterial scattering unit cell, the magnetic field component of the guided wave induces a magnetic excitation of the CELC, which, in turn, produces an electromagnetic wave in the same frequency as the guided wave.

The phase of the electromagnetic wave generated by a single CELC can be selected by the position of the CELC on the vector of the guided wave. Each cell generates a wave in phase with the guided wave parallel to the CELC. Because the CELCs are smaller than the wave length, the output wave has the same phase as the phase of the guided wave as it passes beneath the CELC.

In one embodiment, the cylindrical feed geometry of this antenna system allows the CELC elements to be positioned at forty five degree (45°) angles to the vector of the wave in the wave feed. This position of the elements enables control of the polarization of the free space wave generated from or received by the elements. In one embodiment, the CELCs are arranged with an inter-element spacing that is less than a free-space wavelength of the operating frequency of the antenna. For example, if there are four scattering elements per wavelength, the elements in the 30 GHz transmit antenna will be approximately 2.5 mm (i.e., ¼th the 10 mm free-space wavelength of 30 GHz).

In one embodiment, the CELCs are implemented with patch antennas that include a patch co-located over a slot with liquid crystal between the two. In this respect, the metamaterial antenna acts like a slotted (scattering) wave guide. With a slotted wave guide, the phase of the output wave depends on the location of the slot in relation to the guided wave.

### Cell Placement

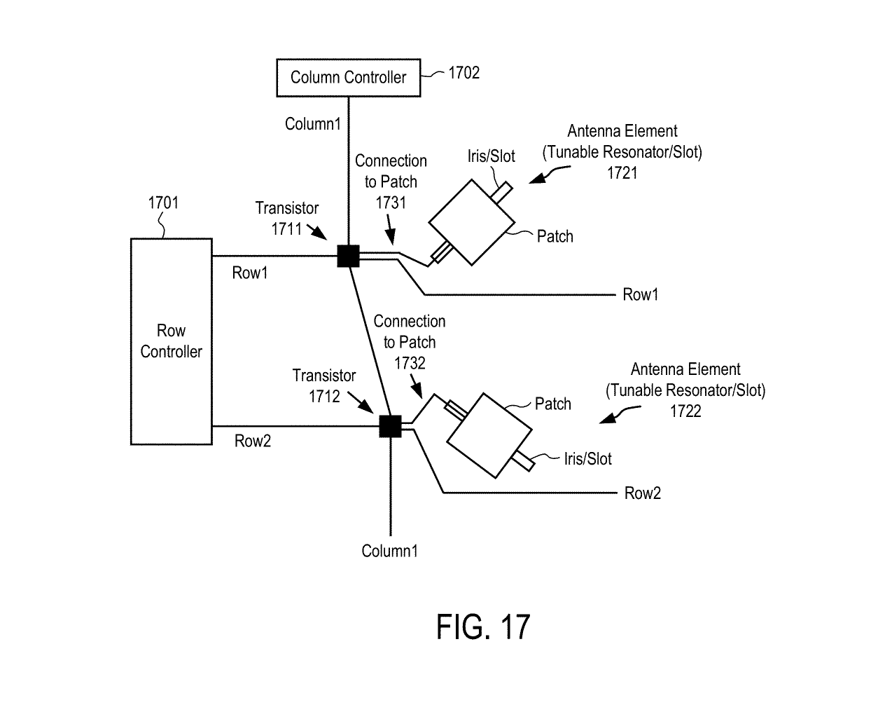

In one embodiment, the antenna elements are placed on the cylindrical feed antenna aperture in a way that allows for a systematic matrix drive circuit. The placement of the cells includes placement of the transistors for the matrix drive. FIG. 17 illustrates one embodiment of the placement of matrix drive circuitry with respect to antenna elements. Referring to FIG. 17, row controller 1701 is coupled to transistors 1711 and 1712, via row select signals Row1 and Row2, respectively, and column controller 1702 is coupled to transistors 1711 and 1712 via column select signal Column1. Transistor 1711 is also coupled to antenna element 1721 via connection to patch 1731, while transistor 1712 is coupled to antenna element 1722 via connection to patch 1732.

In an initial approach to realize matrix drive circuitry on the cylindrical feed antenna with unit cells placed in a non-regular grid, two steps are performed. In the first step, the cells are placed on concentric rings and each of the cells is connected to a transistor that is placed beside the cell and acts as a switch to drive each cell separately. In the second step, the matrix drive circuitry is built in order to connect every transistor with a unique address as the matrix drive approach requires. Because the matrix drive circuit is built by row and column traces (similar to LCDs) but the cells are placed on rings, there is no systematic way to assign a unique address to each transistor. This mapping problem results in very complex circuitry to cover all the transistors and leads to a significant increase in the number of physical traces to accomplish the routing. Because of the high density of cells, those traces disturb the RF performance of the antenna due to coupling effect. Also, due to the complexity of traces and high packing density, the routing of the traces cannot be accomplished by commercially available layout tools.

In one embodiment, the matrix drive circuitry is predefined before the cells and transistors are placed. This ensures a minimum number of traces that are necessary to drive all the cells, each with a unique address. This strategy reduces the complexity of the drive circuitry and simplifies the routing, which subsequently improves the RF performance of the antenna.

More specifically, in one approach, in the first step, the cells are placed on a regular rectangular grid composed of rows and columns that describe the unique address of each cell. In the second step, the cells are grouped and transformed to concentric circles while maintaining their address and connection to the rows and columns as defined in the first step. A goal of this transformation is not only to put the cells on rings but also to keep the distance between cells and the distance between rings constant over the entire aperture. In order to accomplish this goal, there are several ways to group the cells.

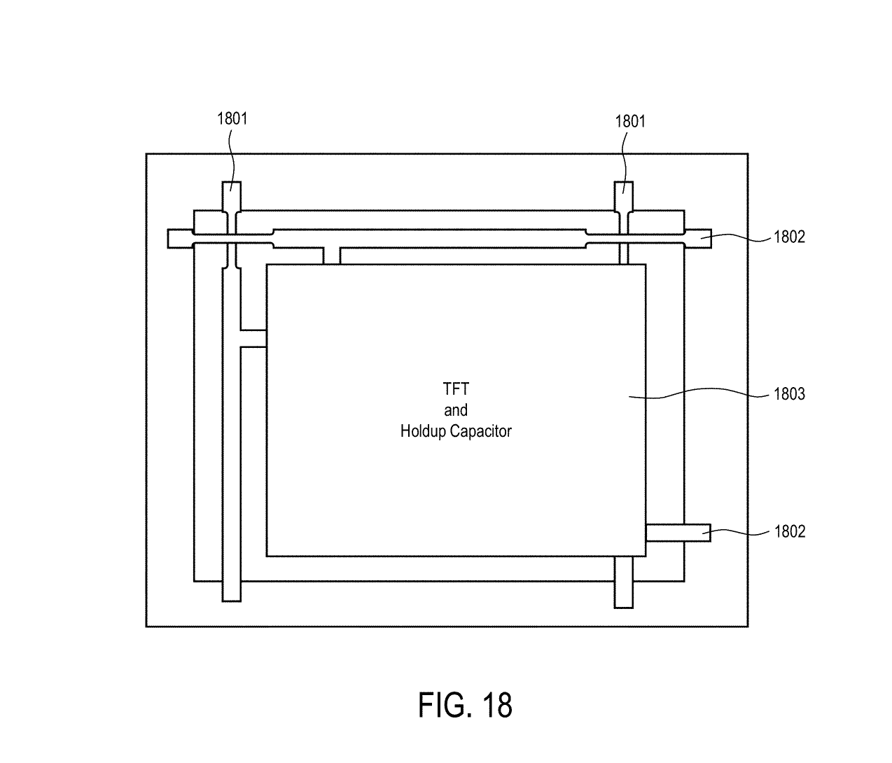

In one embodiment, a TFT package is used to enable placement and unique addressing in the matrix drive. FIG. 18 illustrates one embodiment of a TFT package. Referring to FIG. 18, a TFT and a hold capacitor 1803 is shown with input and output ports. There are two input ports connected to traces 1801 and two output ports connected to traces 1802 to connect the TFTs together using the rows and columns. In one embodiment, the row and column traces cross in 90° angles to reduce, and potentially minimize, the coupling between the row and column traces. In one embodiment, the row and column traces are on different layers.

### An Example System Embodiment

In one embodiment, the combined antenna apertures are used in a television system that operates in conjunction with a set top box. For example, in the case of a dual reception antenna, satellite signals received by the antenna are provided to a set top box (e.g., a DirecTV receiver) of a television system. More specifically, the combined antenna operation is able to simultaneously receive RF signals at two different frequencies and/or polarizations. That is, one sub-array of elements is controlled to receive RF signals at one frequency and/or polarization, while another sub-array is controlled to receive signals at another, different frequency and/or polarization. These differences in frequency or polarization represent different channels being received by the television system. Similarly, the two antenna arrays can be controlled for two different beam positions to receive channels from two different locations (e.g., two different satellites) to simultaneously receive multiple channels.

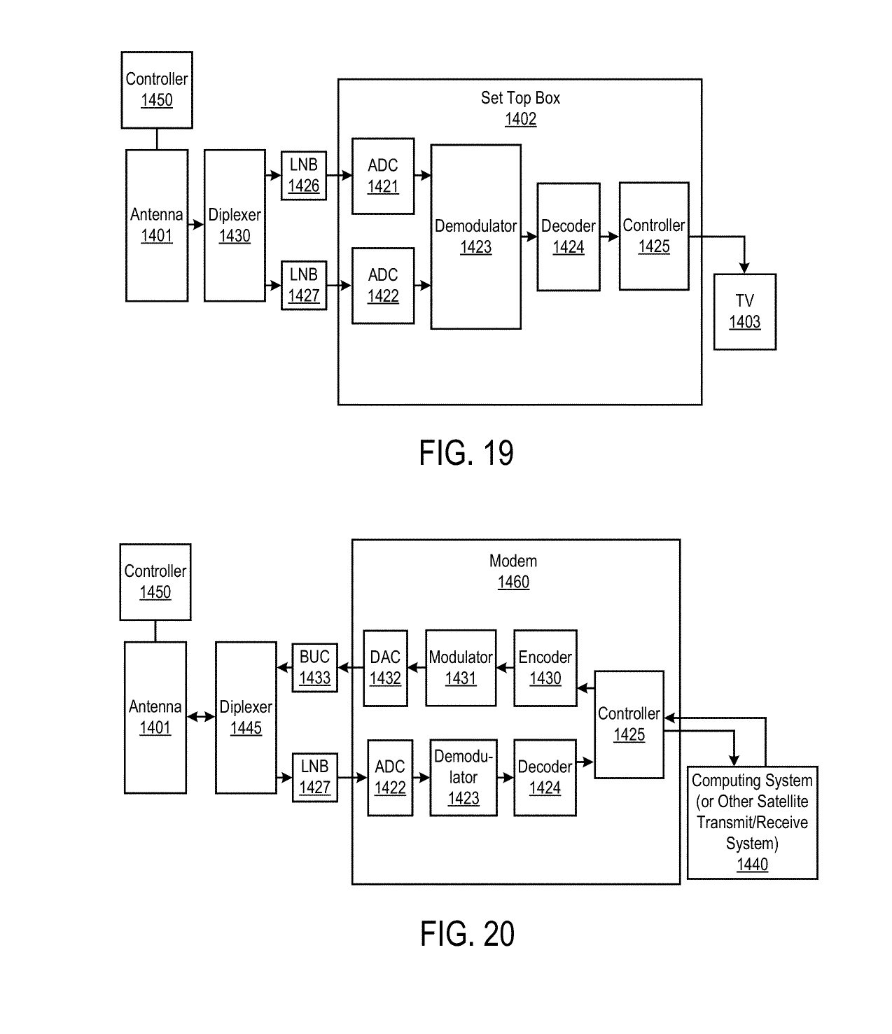

FIG. 19 is a block diagram of one embodiment of a communication system that performs dual reception simultaneously in a television system. Referring to FIG. 19, antenna 1401 includes two spatially interleaved antenna apertures operable independently to perform dual reception simultaneously at different frequencies and/or polarizations as described above. Note that while only two spatially interleaved antenna operations are mentioned, the TV system may have more than two antenna apertures (e.g., 3, 4, 5, etc. antenna apertures).

In one embodiment, antenna 1401, including its two interleaved slotted arrays, is coupled to diplexer 1430. The coupling may include one or more feeding networks that receive the signals from elements of the two slotted arrays to produce two signals that are fed into diplexer 1430. In one embodiment, diplexer 1430 is a commercially available diplexer (e.g., model PB1081WA Ku-band sitcom diplexor from A1 Microwave).

Diplexer 1430 is coupled to a pair of low noise block down converters (LNBs) 1426 and 1427, which perform a noise filtering function, a down conversion function, and amplification in a manner well-known in the art. In one embodiment, LNBs 1426 and 1427 are in an out-door unit (ODU). In another embodiment, LNBs 1426 and 1427 are integrated into the antenna apparatus. LNBs 1426 and 1427 are coupled to a set top box 1402, which is coupled to television 1403.

Set top box 1402 includes a pair of analog-to-digital converters (ADCs) 1421 and 1422, which are coupled to LNBs 1426 and 1427, to convert the two signals output from diplexer 1430 into digital format.

Once converted to digital format, the signals are demodulated by demodulator 1423 and decoded by decoder 1424 to obtain the encoded data on the received waves. The decoded data is then sent to controller 1425, which sends it to television 1403.

Controller 1450 controls antenna 1401, including the interleaved slotted array elements of both antenna apertures on the single combined physical aperture.

### An Example of a Full Duplex Communication System

In another embodiment, the combined antenna apertures are used in a full duplex communication system. FIG. 1B0 is a block diagram of another embodiment of a communication system having simultaneous transmit and receive paths. While only one transmit path and one receive path are shown, the communication system may include more than one transmit path and/or more than one receive path.

Referring to FIG. 1BO, antenna 1401 includes two spatially interleaved antenna arrays operable independently to transmit and receive simultaneously at different frequencies as described above. In one embodiment, antenna 1401 is coupled to diplexer 1445. The coupling may be by one or more feeding networks. In one embodiment, in the case of a radial feed antenna, diplexer 1445 combines the two signals and the connection between antenna 1401 and diplexer 1445 is a single broad-band feeding network that can carry both frequencies.

Diplexer 1445 is coupled to a low noise block down converter (LNBs) 1427, which performs a noise filtering function and a down conversion and amplification function in a manner well-known in the art. In one embodiment, LNB 1427 is in an out-door unit (ODU). In another embodiment, LNB 1427 is integrated into the antenna apparatus. LNB 1427 is coupled to a modem 1460, which is coupled to computing system 1440 (e.g., a computer system, modem, etc.).

Modem 1460 includes an analog-to-digital converter (ADC) 1422, which is coupled to LNB 1427, to convert the received signal output from diplexer 1445 into digital format. Once converted to digital format, the signal is demodulated by demodulator 1423 and decoded by decoder 1424 to obtain the encoded data on the received wave. The decoded data is then sent to controller 1425, which sends it to computing system 1440.

Modem 1460 also includes an encoder 1430 that encodes data to be transmitted from computing system 1440. The encoded data is modulated by modulator 1431 and then converted to analog by digital-to-analog converter (DAC) 1432. The analog signal is then filtered by a BUC (up-convert and high pass amplifier) 1433 and provided to one port of diplexer 1445. In one embodiment, BUC 1433 is in an out-door unit (ODU).

Diplexer 1445 operating in a manner well-known in the art provides the transmit signal to antenna 1401 for transmission.

Controller 1450 controls antenna 1401, including the two arrays of antenna elements on the single combined physical aperture.

Note that the full duplex communication system shown in FIG. 1B0 has a number of applications, including but not limited to, internet communication, vehicle communication (including software updating), etc.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; etc.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

We claim:

1. A retention apparatus for use in coupling to an antenna aperture during manufacturing, the retention apparatus comprising:
a base plate;
a plurality of clamps coupled to the base plate, each clamp of the plurality of clamps being rotatable to couple the antenna aperture to the base plate; and
one or more component holders coupled to the base plate, each of the one or more component holders to securely hold at least one component that is coupled to the antenna aperture.

2. The retention apparatus defined in claim 1 wherein the one or more components comprise printed circuit substrates with one or more integrated circuit components coupled thereto.

3. The retention apparatus defined in claim 1 wherein each of the one or more component holders comprises:
a first bracket; and
a removable retainer plate coupled to the first bracket.

4. The retention apparatus defined in claim 3 further comprising a first foam cushion attached to the first bracket and a second foam cushion attached to the retainer plate to cushion the antenna component when the first bracket and the retainer plate are coupled together.

5. The retention apparatus defined in claim 3 further comprising a plurality of latches coupled to the first bracket and the removable retainer plate to cause the first bracket and the removable retainer plate to clamp towards each other to secure at least one component that is coupled to the antenna aperture.

6. The retention apparatus defined in claim 5 wherein the first bracket comprises a T-Iron bracket and the latch comprises a strikeless draw latch.

7. The retention apparatus defined in claim 1 further comprising:
a plurality of rods, each rod of the plurality rods coupled to a distinct clamp of the plurality of clamps; and
a plurality of nuts, each nut of the plurality nuts coupled to a distinct rod of the plurality of rods and to secures a clamp in place when the clamp couples the base plate to the aperture.

8. The retention apparatus defined in claim 1 further comprising a plurality of standoffs coupled to the base plate.

9. The retention apparatus defined in claim 1 further comprising a plurality of second brackets coupled to the base plate for handling the base plate.

10. The retention apparatus defined in claim 9 further comprising a plurality of handles, each handle of the plurality of handles being coupled to a distinct one of the plurality of second brackets.

11. The retention apparatus defined in claim 9 wherein the second brackets comprise L iron brackets.

12. The retention apparatus defined in claim 1 wherein the base plate has a centrally located open area and has foam to cushion a cover of the antenna aperture when the antenna aperture rests on a portion of the base plate and is clamped to the base plate.

13. The retention apparatus defined in claim 12 wherein the cover is a radome.

14. An assembly process comprising:
holding an aperture with a retention apparatus by clamping a cover of the aperture, the aperture coupled to one or more antenna components, the one or more antenna components securely held in place by the retention apparatus;
flipping of the retention apparatus and the aperture while the antenna aperture is held by the retention apparatus and while retaining the one or more antenna components in place; and
supporting the retention apparatus on a surface using supports on the retention apparatus to hold the antenna aperture above the surface.

15. The process defined in claim 14 wherein the one or more antenna components comprise printed circuit boards (PCBs).

16. The process defined in claim 15 wherein the at least one PCB comprises a breakout board.

17. The process defined in claim 14 wherein the cover comprises a radome.

18. The process defined in claim 14 wherein the aperture comprises a TFT aperture and the one or more antenna components comprises PCBs coupled to the antenna aperture using flexible connectors.

19. A retention apparatus for use in coupling to an antenna aperture during manufacturing, the retention apparatus comprising:
a base plate;
a plurality of clamps coupled to the base plate, each clamp of the plurality of clamps being rotatable to couple the antenna aperture to the base plate; and
one or more component holders coupled to the base plate, each of the one or more component holders to securely hold at least one component that is coupled to the antenna aperture, wherein each of the one or more component holders comprises a first bracket and a removable retainer plate coupled to the first bracket; and
a second bracket.

20. The retention apparatus defined in claim 19 further comprising:
a first foam cushion attached to the first bracket;
a second foam cushion attached to the retainer plate, the first and second foam cushions to cushion the antenna component when the first bracket and the retainer plate are coupled together; and
a latch coupled to the first bracket and the removable retainer plate to cause the first bracket and the removable retainer plate to clamp towards each other to secure at least one component that is coupled to the antenna aperture.
